(19) United States
(12) Patent Application Publication
(10) Pub. No.: US 2017/0180089 A1
(43) Pub. Date: Jun. 22, 2017

(54) CHANNEL COORDINATION IN A NETWORK OF MOVING THINGS

(71) Applicant: Veniam, Inc., Mountain View, CA (US)

(72) Inventor: Carlos Eduardo Braga Ameixieira, Porto (PT)

(21) Appl. No.: 15/267,466

(22) Filed: Sep. 16, 2016

Related U.S. Application Data
(60) Provisional application No. 62/270,858, filed on Dec. 22, 2015.

(51) Int. Cl. H04L 5/00; H04L 29/08; H04L 12/50

(52) U.S. Cl. CPC H04L 5/0035; H04L 12/50; H04L 67/12; H04W 88/02

(57) ABSTRACT

Communication network architectures, systems and methods for supporting channel coordination in a network of fixed and mobile nodes. Nodes in the network may evaluate conditions, may select a radio frequency channel for operation, and may broadcast information identifying the selected radio frequency channel to neighboring nodes, enabling communication between the nodes of the network.

### CROSS-REFERENCE TO RELATED APPLICATIONS/INCORPORATION BY REFERENCE

This patent application makes reference to, claims priority to, and claims benefit from U.S. Provisional Patent Application Ser. No. 62/270,858, filed on Dec. 22, 2015, and titled “Channel Coordination in a Network of Moving Things,” which is hereby incorporated herein by reference in its entirety. The present application is also related to U.S. Provisional Application Ser. No. 62/221,997, titled “Integrated Communication Network for a Network of Moving Things,” filed on Sep. 22, 2015; U.S. Provisional Application Ser. No. 62/222,016, titled “Systems and Methods for Synchronizing a Network of Moving Things,” filed on Sep. 22, 2015; U.S. Provisional Application Ser. No. 62/222,042, titled “Systems and Methods for Managing a Network of Moving Things,” filed on Sep. 22, 2015; U.S. Provisional Application Ser. No. 62/222,066, titled “Systems and Methods for Monitoring a Network of Moving Things,” filed on Sep. 22, 2015; U.S. Provisional Application Ser. No. 62/222,077, titled “Systems and Methods for Detecting and Classifying Anomalies in a Network of Moving Things,” filed on Sep. 22, 2015; U.S. Provisional Application Ser. No. 62/222,098, titled “Systems and Methods for Managing Mobility in a Network of Moving Things,” filed on Sep. 22, 2015; U.S. Provisional Application Ser. No. 62/222,121, titled “Systems and Methods for Managing Connectivity a Network of Moving Things,” filed on Sep. 22, 2015; U.S. Provisional Application Ser. No. 62/222,135, titled “Systems and Methods for Collecting Sensor Data in a Network of Moving Things,” filed on Sep. 22, 2015; U.S. Provisional Application Ser. No. 62/222,145, titled “Systems and Methods for Interfacing with a Network of Moving Things,” filed on Sep. 22, 2015; U.S. Provisional Application Ser. No. 62/222,150, titled “Systems and Methods for Interfacing with a User of a Network of Moving Things,” filed on Sep. 22, 2015; U.S. Provisional Application Ser. No. 62/222,168, titled “Systems and Methods for Data Storage and Processing for a Network of Moving Things,” filed on Sep. 22, 2015; U.S. Provisional Application Ser. No. 62/222,183, titled “Systems and Methods for Vehicle Traffic Management in a Network of Moving Things,” filed on Sep. 22, 2015; U.S. Provisional Application Ser. No. 62/222,186, titled “Systems and Methods for Environmental Management in a Network of Moving Things,” filed on Sep. 22, 2015; U.S. Provisional Application Ser. No. 62/222,190, titled “Systems and Methods for Port Management in a Network of Moving Things,” filed on Sep. 22, 2015; U.S. Provisional Patent Application Ser. No. 62/222,192, titled “Communication Network of Moving Things,” filed on Sep. 22, 2015; U.S. Provisional Application Ser. No. 62/244,828, titled “Utilizing Historical Data to Correct GPS Data in a Network of Moving Things,” filed on Oct. 22, 2015; U.S. Provisional Application Ser. No. 62/244,930, titled “Using Anchors to Correct GPS Data in a Network of Moving Things,” filed on Oct. 22, 2015; U.S. Provisional Application Ser. No. 62/246,368, titled “Systems and Methods for Inter-Application Communication in a Network of Moving Things,” filed on Oct. 26, 2015; U.S. Provisional Application Ser. No. 62/246,372, titled “Systems and Methods for Probing and Validating Communication in a Network of Moving Things,” filed on Oct. 26, 2015; U.S. Provisional Application Ser. No. 62/250,544, titled “Adaptive Rate Control for Vehicular Networks,” filed on Nov. 4, 2015; U.S. Provisional Application Ser. No. 62/273,878, titled “Systems and Methods for Reconfiguring and Adapting Hardware in a Network of Moving Things,” filed on Dec. 31, 2015; U.S. Provisional Application Ser. No. 62/253,249, titled “Systems and Methods for Optimizing Data Gathering in a Network of Moving Things,” filed on Nov. 10, 2015; U.S. Provisional Application Ser. No. 62/257,421, titled “Systems and Methods for Delay Tolerant Networking in a Network of Moving Things,” filed on Nov. 19, 2015; U.S. Provisional Application Ser. No. 62/265,267, titled “Systems and Methods for Improving Coverage and Throughput of Mobile Access Points in a Network of Moving Things,” filed on Dec. 9, 2015; U.S. Provisional Application Ser. No. 62/270,858, titled “Channel Coordination in a Network of Moving Things,” filed on Dec. 22, 2015; U.S. Provisional Application Ser. No. 62/257,854, titled “Systems and Methods for Network Coded Mesh Networking in a Network of Moving Things,” filed on Nov. 20, 2015; U.S. Provisional Application Ser. No. 62/260,749, titled “Systems and Methods for Improving Fixed Access Point Coverage in a Network of Moving Things,” filed on Nov. 30, 2015; U.S. Provisional Application Ser. No. 62/273,715, titled “Systems and Methods for Managing Mobility Controllers and Their Network Interactions in a Network of Moving Things,” filed on Dec. 31, 2015; U.S. Provisional Application Ser. No. 62/281,432, titled “Systems and Methods for Managing and Triggering Handovers of Mobile Access Points in a Network of Moving Things,” filed on Jan. 21, 2016; U.S. Provisional Application Ser. No. 62/268,188, titled “Captive Portal-related Control and Management in a Network of Moving Things,” filed on Dec. 16, 2015; U.S. Provisional Application Ser. No. 62/270,678, titled “Systems and Methods to Extrapolate High-Value Data from a Network of Moving Things,” filed on Dec. 22, 2015; U.S. Provisional Application Ser. No. 62/272,750, titled “Systems and Methods for Remote Software Update and Distribution in a Network of Moving Things,” filed on Dec. 30, 2015; U.S. Provisional Application Ser. No. 62/278,662, titled “Systems and Methods for Remote Configuration Update and Distribution in a Network of Moving Things,” filed on Jan. 14, 2016; U.S. Provisional Application Ser. No. 62/286,243, titled “Systems and Methods for Adapting a Network of Moving Things Based on User Feedback,” filed on Jan. 22, 2016; U.S. Provisional Application Ser. No. 62/278,764, titled “Systems and Methods to Guarantee Data Integrity When Building Data Analytics in a Network of Moving Things,” Jan. 14, 2016; U.S. Provisional Application Ser. No. 62/286,515, titled “Systems and Methods for Self-Initialization and Automated Bootstrapping of Mobile Access Points in a Network of Moving Things,” filed on Jan. 25, 2016; U.S. Provisional Application Ser. No. 62/295,602, titled “Systems and Methods for Power Management in a Network of Moving Things,” filed on Feb. 16, 2016; and U.S. Provisional Application Ser. No. 62/299,269, titled “Systems and Methods for Automating and Easing the Installation and Setup of the Infrastructure Supporting a Network of Moving Things,” filed on Feb. 24, 2016; each of which is hereby incorporated herein by reference in its entirety for all purposes.

### BACKGROUND

Current communication networks are unable to adequately support communication environments involving mobile and static nodes. As a non-limiting example, current communication networks are unable to adequately support a network comprising a complex array of both moving and static nodes (e.g., the Internet of moving things). Limitations and disadvantages of conventional methods and systems will become apparent to one of skill in the art, through comparison of such approaches with some aspects of the present methods and systems set forth in the remainder of this disclosure with reference to the drawings.

### BRIEF DESCRIPTION OF SEVERAL VIEWS OF THE DRAWINGS

FIG. 1 shows a block diagram of a communication network, in accordance with various aspects of this disclosure.

FIG. 2 shows a block diagram of a communication network, in accordance with various aspects of this disclosure.

FIG. 3 shows a diagram of a metropolitan area network, in accordance with various aspects of this disclosure.

FIG. 4 shows a block diagram of a communication network, in accordance with various aspects of this disclosure.

FIGS. 5A-5C show a plurality of network configurations illustrating the flexibility and/or and resiliency of a communication network, in accordance with various aspects of this disclosure.

FIG. 6 shows a block diagram of an example communication network, in accordance with various aspects of the present disclosure.

FIG. 7 is an illustration showing an example network node (e.g., a fixed or mobile AP) of a network of moving things, in accordance with various aspects of the present disclosure.

FIG. 8 is a flowchart illustrating an example process for RF channel selection that may be implemented by a CCME of a mobile AP node corresponding to, for example, the CCME of FIG. 7, in a network of moving things in accordance with various aspects of the present disclosure.

FIG. 9 is a flowchart illustrating an example process for RF channel selection that may be implemented by a CCME of a fixed AP node in a network of moving things in accordance with various aspects of the present disclosure.

FIG. 10 is a flowchart illustrating an example process for performing channel evaluation in accordance with various aspects of the present disclosure.

FIG. 11 illustrates a block diagram showing a fixed AP and a mobile AP communicating with one another in a manner discussed, below, with respect to FIG. 12, in accordance with various aspects of the present disclosure.

FIG. 12 illustrates an example process in which a fixed AP and a mobile AP such as, for example, the fixed AP and mobile AP of FIG. 11, decide upon a channel via which to communicate, in accordance with aspects of this disclosure.

### SUMMARY

Various aspects of this disclosure provide communication network architectures, systems and methods for supporting a network of mobile and/or static nodes. As a non-limiting example, various aspects of this disclosure provide communication network architectures, systems, and methods for supporting channel coordination in a dynamically configurable communication network comprising a complex array of both static and moving communication nodes (e.g., the Internet of moving things). For example, a communication network implemented in accordance with various aspects of the present disclosure may operate in one of a plurality of modalities comprising various fixed nodes, mobile nodes, and/or a combination thereof, which are selectable to achieve any of a variety of system goals.

### DETAILED DESCRIPTION OF VARIOUS ASPECTS OF THE DISCLOSURE

As utilized herein the terms “circuits” and “circuitry” refer to physical electronic components (i.e., hardware) and any software and/or firmware (“code”) that may configure the hardware, be executed by the hardware, and or otherwise be associated with the hardware. As used herein, for example, a particular processor and memory (e.g., a volatile or non-volatile memory device, a general computer-readable medium, etc.) may comprise a first “circuit” when executing a first one or more lines of code and may comprise a second “circuit” when executing a second one or more lines of code. Additionally, a circuit may comprise analog and/or digital circuitry. Such circuitry may, for example, operate on analog and/or digital signals. It should be understood that a circuit may be in a single device or chip, on a single motherboard, in a single chassis, in a plurality of enclosures at a single geographical location, in a plurality of enclosures distributed over a plurality of geographical locations, etc. Similarly, the term “module” may, for example, refer to a physical electronic components (i.e., hardware) and any software and/or firmware (“code”) that may configure the hardware, be executed by the hardware, and or otherwise be associated with the hardware.

As utilized herein, circuitry is “operable” to perform a function whenever the circuitry comprises the necessary hardware and code (if any is necessary) to perform the function, regardless of whether performance of the function is disabled, or not enabled (e.g., by a user-configurable setting, factory setting or trim, etc.).

As utilized herein, “and/or” means any one or more of the items in the list joined by “and/or”. As an example, “x and/or y” means any element of the three-element set {(x), (y), (x, y)}. That is, “x and/or y” means “one or both of x and y.” As another example, “x, y, and/or z” means any element of the seven-element set {(x), (y), (z), (x, y), (x, z), (y, z), (x, y, z)}. That is, “x, y, and/or x” means “one or more of x, y, and z.” As utilized herein, the terms “e.g.,” and “for example,” “exemplary,” and the like set off lists of one or more non-limiting examples, instances, or illustrations.

The terminology used herein is for the purpose of describing particular examples only and is not intended to be limiting of the disclosure. As used herein, the singular forms are intended to include the plural forms as well, unless the context clearly indicates otherwise. It will be further understood that the terms “comprises,” “includes,” “comprising,” “including,” “has,” “have,” “having,” and the like when used in this specification, specify the presence of stated features, integers, steps, operations, elements, and/or components, but do not preclude the presence or addition of one or more other features, integers, steps, operations, elements, components, and/or groups thereof.

It will be understood that, although the terms first, second, etc. may be used herein to describe various elements, these elements should not be limited by these terms. These terms are only used to distinguish one element from another element. Thus, for example, a first element, a first component or a first section discussed below could be termed a second element, a second component or a second section without departing from the teachings of the present disclosure. Similarly, various spatial terms, such as “upper,” “lower,” “side,” and the like, may be used in distinguishing one element from another element in a relative manner. It should be understood, however, that components may be oriented in different manners, for example an electronic device may be turned sideways so that its “top” surface is facing horizontally and its “side” surface is facing vertically, without departing from the teachings of the present disclosure.

With the proliferation of the mobile and/or static things (e.g., devices, machines, people, etc.) and logistics for such things to become connected to each other (e.g., in the contexts of smart logistics, transportation, environmental sensing, etc.), a platform that is for example always-on, robust, scalable and secure that is capable of providing connectivity, services and Internet access to such things (or objects), anywhere and anytime is desirable. Efficient power utilization within the various components of such system is also desirable.

Accordingly, various aspects of the present disclosure provide a fully-operable, always-on, responsive, robust, scalable, secure platform/system/architecture to provide connectivity, services and Internet access to all mobile things and/or static things (e.g., devices, machines, people, access points, end user devices, sensors, etc.) anywhere and anytime, while operating in an energy-efficient manner.

Various aspects of the present disclosure provide a platform that is flexibly configurable and adaptable to the various requirements, features, and needs of different environments, where each environment may be characterized by a respective level of mobility and density of mobile and/or static things, and the number and/or types of access to those things. Characteristics of various environments may, for example, include high mobility of nodes (e.g., causing contacts or connections to be volatile), high number of neighbors, high number of connected mobile users, mobile access points, availability of multiple networks and technologies (e.g., sometimes within a same area), etc. For example, the mode of operation of the platform may be flexibly adapted from environment to environment, based on each environment's respective requirements and needs, which may be different from other environments. Additionally for example, the platform may be flexibly optimized (e.g., at design/installation time and/or in real-time) for different purposes (e.g., to reduce the latency, increase throughput, reduce power consumption, load balance, increase reliability, make more robust with regard to failures or other disturbances, etc.), for example based on the content, service or data that the platform provides or handles within a particular environment.

In accordance with various aspects of the present disclosure, many control and management services (e.g., mobility, security, routing, etc.) are provided on top of the platform (e.g., directly, using control overlays, using containers, etc.), such services being compatible with the services currently deployed on top of the Internet or other communication network(s).

The communication network (or platform), in whole or in part, may for example be operated in public and/or private modes of operation, for example depending on the use case. The platform may, for example, operate in a public or private mode of operation, depending on the use-case (e.g., public Internet access, municipal environment sensing, fleet operation, etc.).

Additionally for example, in an implementation in which various network components are mobile, the transportation and/or signal control mechanisms may be adapted to serve the needs of the particular implementation. Also for example, wireless transmission power and/or rate may be adapted (e.g., to mitigate interference, to reduce power consumption, to extend the life of network components, etc.

Various example implementations of a platform, in accordance with various aspects of the present disclosure, are capable of connecting different subsystems, even when various other subsystems that may normally be utilized are unavailable. For example, the platform may comprise various built-in redundancies and fail-recovery mechanisms. For example, the platform may comprise a self-healing capability, self-configuration capability, self-adaptation capability, etc. The protocols and functions of the platform may, for example, be prepared to be autonomously and smoothly configured and adapted to the requirements and features of different environments characterized by different levels of mobility and density of things (or objects), the number/types of access to those things. For example, various aspects of the platform may gather context parameters that can influence any or all decisions. Such parameters may, for example, be derived locally, gathered from a neighborhood, fixed APs, the Cloud, etc. Various aspects of the platform may also, for example, ask for historical information to feed any of the decisions, where such information can be derived from historical data, from surveys, from simulators, etc. Various aspects of the platform may additionally, for example, probe or monitor decisions made throughout the network, for example to evaluate the network and/or the decisions themselves in real-time. Various aspects of the platform may further, for example, enforce the decisions in the network (e.g., after evaluating the probing results). Various aspects of the platform may, for example, establish thresholds to avoid any decision that is to be constantly or repeatedly performed without any significant advantage (e.g., technology change, certificate change, IP change, etc.). Various aspects of the platform may also, for example, learn locally (e.g., with the decisions performed) and dynamically update the decisions.

In addition to (or instead of) failure robustness, a platform may utilize multiple connections (or pathways) that exist between distinct sub-systems or elements within the same sub-system, to increase the robustness and/or load-balancing of the system.

The following discussion will present examples of the functionality performed by various example subsystems of the communication network. It should be understood that the example functionality discussed herein need not be performed by the particular example subsystem or by a single subsystem. For example, the subsystems present herein may interact with each other, and data or control services may be deployed either in a centralized way, or having their functionalities distributed among the different subsystems, for example leveraging the cooperation between the elements of each subsystem.

Various aspects of the present disclosure provide a communication network (e.g., a city-wide vehicular network, a shipping port-sized vehicular network, a campus-wide vehicular network, etc.) that utilizes vehicles (e.g., automobiles, buses, trucks, boats, forklifts, etc.) as Wi-Fi hotspots. Note that Wi-Fi is generally used throughout this discussion as an example, but the scope of various aspects of this disclosure is not limited thereto. For example, other wireless LAN technologies, PAN technologies, MAN technologies, etc., may be utilized. Such utilization may, for example, provide cost-effective ways to gather substantial amounts of urban data, and provide for the efficient offloading of traffic from congested cellular networks (or other networks). In controlled areas (e.g., ports, harbors, etc.) with many vehicles, a communication network in accordance with various aspects of this disclosure may expand the wireless coverage of existing enterprise Wi-Fi networks, for example providing for real-time communication with vehicle drivers (e.g., human, computer-controlled, etc.) and other mobile employees without the need for SIM cards or cellular (or other network) data plans.

Vehicles may have many advantageous characteristics that make them useful as Wi-Fi (or general wireless) hotspots. For example, vehicles generally have at least one battery, vehicles are generally densely spread over the city at street level and/or they are able to establish many contacts with each other in a controlled space, and vehicles can communicate with 10x the range of normal Wi-Fi in the 5.9 GHz frequency band, reserved for intelligent transportation systems in the EU, the U.S., and elsewhere. Note that the scope of this disclosure is not limited to such 5.9 GHz wireless communication. Further, vehicles are able to effectively expand their coverage area into a swath over a period of time, enabling a single vehicle access point to interact with substantially more data sources over the period of time.

In accordance with various aspects of the present disclosure, an affordable multi-network on-board unit (OBU) is presented. Note that the OBU may also be referred to herein as a mobile access point, Mobile AP, MAP, etc. The OBU may, for example, comprise a plurality of networking interfaces (e.g., Wi-Fi, 802.11p, 4G, Bluetooth, UWB, etc.). The OBU may, for example, be readily installed in or on private and/or public vehicles (e.g., individual user vehicles, vehicles of private fleets, vehicles of public fleets, etc.). The OBU may, for example, be installed in transportation fleets, waste management fleets, law enforcement fleets, emergency services, road maintenance fleets, taxi fleets, aircraft fleets, etc. The OBU may, for example, be installed in or on a vehicle or other structure with free mobility or relatively limited mobility. The OBU may also, for example, be carried by a person or service animal, mounted to a bicycle, mounted to a moving machine in general, mounted to a container, etc.

The OBUs may, for example, operate to connect passing vehicles to the wired infrastructure of one or more network providers, telecom operators, etc. In accordance with the architecture, hardware, and software functionality discussed herein, vehicles and fleets can be connected not just to the cellular networks (or other wide area or metropolitan area networks, etc.) and existing Wi-Fi hotspots spread over a city or a controlled space, but also to other vehicles (e.g., utilizing multi-hop communications to a wired infrastructure, single or multi-hop peer-to-peer vehicle communication, etc.). The vehicles and/or fleets may, for example, form an overall mesh of communication links, for example including the OBUs and also fixed Access Points (APs) connected to the wired infrastructure (e.g., a local infrastructure, etc.). Note that OBUs herein may also be referred to as “Mobile APs,” “mobile hotspots,” “MAPs,” etc. Also note that fixed access points may also be referred to herein as Road Side Units (RSUs), Fixed APs, FAPs, etc.

In an example implementation, the OBUs may communicate with the Fixed APs utilizing a relatively long-range protocol (e.g., 802.11p, etc.), and the Fixed APs may, in turn, be hard wired to the wired infrastructure (e.g., via cable, tethered optical link, etc.). Note that Fixed APs may also, or alternatively, be coupled to the infrastructure via wireless link (e.g., 802.11p, etc.). Additionally, clients or user devices may communicate with the OBUs using one or more relatively short-range protocols (e.g., Wi-Fi, Bluetooth, UWB, etc.). The OBUs, for example having a longer effective wireless communication range than typical Wi-Fi access points or other wireless LAN/PAN access points (e.g., at least for links such as those based on 802.11p, etc.), are capable of substantially greater coverage areas than typical Wi-Fi or other wireless LAN/PAN access points, and thus fewer OBUs are necessary to provide blanket coverage over a geographical area.

The OBU may, for example, comprise a robust vehicular networking module (e.g., a connection manager) which builds on long-range communication protocol capability (e.g., 802.11p, etc.). For example, in addition to comprising 802.11p (or other long-range protocol) capability to communicate with Fixed APs, vehicles, and other nodes in the network, the OBU may comprise a network interface (e.g., 802.11a/b/g/n, 802.11ac, 802.11af, any combination thereof, etc.) to provide wireless local area network (WLAN) connectivity to end user devices, sensors, fixed Wi-Fi access points, etc. For example, the OBU may operate to provide in-vehicle Wi-Fi Internet access to users in and/or around the vehicle (e.g., a bus, train car, taxi cab, public works vehicle, etc.). The OBU may further comprise one or more wireless backbone communication interfaces (e.g., cellular network interfaces, etc.). Though in various example scenarios, a cellular network interface (or other wireless backbone communication interface) might not be the preferred interface for various reasons (e.g., cost, power, bandwidth, etc.), the cellular network interface may be utilized to provide connectivity in geographical areas that are not presently supported by a Fixed AP, may be utilized to provide a fail-over communication link, may be utilized for emergency communications, may be utilized to subscribe to local infrastructure access, etc. The cellular network interface may also, for example, be utilized to allow the deployment of solutions that are dependent on the cellular network operators.

An OBU, in accordance with various aspects of the present disclosure, may for example comprise a smart connection manager that can select the best available wireless link(s) (e.g., Wi-Fi, 802.11p, cellular, vehicle mesh, etc.) with which to access the Internet. The OBU may also, for example, provide geo-location capabilities (e.g., GPS, etc.), motion detection sensors to determine if the vehicle is in motion, and a power control subsystem (e.g., to ensure that the OBU does not deplete the vehicle battery, etc.). The OBU may, for example, comprise any or all of the sensors (e.g., environmental sensors, etc.) discussed herein.

The OBU may also, for example, comprise a manager that manages machine-to-machine data acquisition and transfer (e.g., in a real-time or delay-tolerant fashion) to and from the cloud. For example, the OBU may log and/or communicate information of the vehicles.

The OBU may, for example, comprise a connection and/or routing manager that operates to perform routing of communications in a vehicle-to-vehicle/vehicle-to-infrastructure multi-hop communication. A mobility manager (or controller, MC) may, for example, ensure that communication sessions persist over one or more handoff(s) (also referred to herein as a “handover” or “handovers”) (e.g., between different Mobile APs, Fixed APs, base stations, hot spots, etc.), among different technologies (e.g., 802.11p, cellular, Wi-Fi, satellite, etc.), among different MCs (e.g., in a fail-over scenario, load redistribution scenario, etc.), across different interfaces (or ports), etc. Note that the MC may also be referred to herein as a Local Mobility Anchor (LMA), a Network Controller, etc. Note that the MC, or a plurality thereof, may for example be implemented as part of the backbone, but may also, or alternatively, be implemented as part of any of a variety of components or combinations thereof. For example, the MC may be implemented in a Fixed AP (or distributed system thereof), as part of an OBU (or a distributed system thereof), etc. Various non-limiting examples of system components and/or methods are provided in U.S. Provisional Application No. 62/222,098, filed Sep. 22, 2015, and titled “Systems and Method for Managing Mobility in a Network of Moving Things,” the entire contents of which are hereby incorporated herein by reference. Note that in an example implementation including a plurality of MCs, such MCs may be co-located and/or may be geographically distributed.

Various aspects of the present disclosure also provide a cloud-based service-oriented architecture that handles the real-time management, monitoring and reporting of the network and clients, the functionalities required for data storage, processing and management, the Wi-Fi client authentication and Captive Portal display, etc.

A communication network (or component thereof) in accordance with various aspects of the present disclosure may, for example, support a wide range of smart city applications (or controlled scenarios, or connected scenarios, etc.) and/or use-cases, as described herein.

For example, an example implementation may operate to turn each vehicle (e.g., both public and private taxis, buses, trucks, etc.) into a Mobile AP (e.g., a mobile Wi-Fi hotspot), offering Internet access to employees, passengers and mobile users travelling in the city, waiting in bus stops, sitting in parks, etc. Moreover, through an example vehicular mesh network formed between vehicles and/or fleets of vehicles, an implementation may be operable to offload cellular traffic through the mobile Wi-Fi hotspots and/or fixed APs (e.g., 802.11p-based APs) spread over the city and connected to the wired infrastructure of public or private telecom operators in strategic places, while ensuring the widest possible coverage at the lowest possible cost.

An example implementation (e.g., of a communication network and/or components thereof) may, for example, be operable as a massive urban scanner that gathers large amounts of data (e.g., continuously) on-the-move, actionable or not, generated by a myriad of sources spanning from the in-vehicle sensors or On Board Diagnostic System port (e.g., OBD2, etc.), external Wi-Fi/Bluetooth-enabled sensing units spread over the city, devices of vehicles' drivers and passengers (e.g., information characterizing such devices and/or passengers, etc.), positioning system devices (e.g., position information, velocity information, trajectory information, travel history information, etc.), etc.

Depending on the use case, the OBU may for example process (or computer, transform, manipulate, aggregate, summarize, etc.) the data before sending the data from the vehicle, for example providing the appropriate granularity (e.g., value resolution) and sampling rates (e.g., temporal resolution) for each individual application. For example, the OBU may, for example, process the data in any manner deemed advantageous by the system. The OBU may, for example, send the collected data (e.g., raw data, preprocessed data, information of metrics calculated based on the collected data, etc.) to the Cloud (e.g., to one or more networked servers coupled to any portion of the network) in an efficient and reliable manner to improve the efficiency, environmental impact and social value of municipal city operations and transportation services. Various example use cases are described herein.

In an example scenario in which public buses are moving along city routes and/or taxis are performing their private transportation services, the OBU is able to collect large quantities of real-time data from the positioning systems (e.g., GPS, etc.), from accelerometer modules, etc. The OBU may then, for example, communicate such data to the Cloud, where the data may be processed, reported and viewed, for example to support such public or private bus and/or taxi operations, for example supporting efficient remote monitoring and scheduling of buses and taxis, respectively.

In an example implementation, small cameras (or other sensors) may be coupled to small single-board computers (SBCs) that are placed above the doors of public buses to allow capturing image sequences of people entering and leaving buses, and/or on stops along the bus routes in order to estimate the number of people waiting for a bus. Such data may be gathered by the OBU in order to be sent to the Cloud. With such data, public transportation systems may detect peaks; overcrowded buses, routes and stops; underutilized buses, routes and stops; etc., enabling action to be taken in real-time (e.g., reducing bus periodicity to decrease fuel costs and CO₂ emissions where and when passenger flows are smaller, etc.) as well as detecting systematic transportation problems.

An OBU may, for example, be operable to communicate with any of a variety of Wi-Fi-enabled sensor devices equipped with a heterogeneous collection of environmental sensors. Such sensors may, for example, comprise noise sensors (microphones, etc.), gas sensors (e.g., sensing CO, NO₂, O₃, volatile organic compounds (or VOCs), CO₂, etc.), smoke sensors, pollution sensors, meteorological sensors (e.g., sensing temperature, humidity, luminosity, particles, solar radiation, wind speed (e.g., anemometer), wind direction, rain (e.g., a pluviometer), optical scanners, biometric scanners, cameras, microphones, etc.). Such sensors may also comprise sensors associated with users (e.g., vehicle operators or passengers, passersby, etc.) and/or their personal devices (e.g., smart phones or watches, biometrics sensors, wearable sensors, implanted sensors, etc.). Such sensors may, for example, comprise sensors and/or systems associated with on-board diagnostic (OBD) units for vehicles. Such sensors may, for example, comprise positioning sensors (e.g., GPS sensors, Galileo sensors, GLONASS sensors, etc.). Such sensors may, for example, comprise container sensors (e.g., garbage can sensors, shipping container sensors, container environmental sensors, container tracking sensors, etc.).

Once a vehicle enters the vicinity of such a sensor device, a wireless link may be established, so that the vehicle (or OBU thereof) can collect sensor data from the sensor device and upload the collected data to a database in the Cloud. The appropriate action can then be taken. In an example waste management implementation, several waste management (or collection) trucks may be equipped with OBUs that are able to periodically communicate with sensors installed on containers in order to gather information about waste level, time passed since last collection, etc. Such information may then sent to the Cloud (e.g., to a waste management application coupled to the Internet, etc.) through the vehicular mesh network, in order to improve the scheduling and/or routing of waste management trucks. Note that various sensors may always be in range of the Mobile AP (e.g., vehicle-mounted sensors). Note that the sensor may also (or alternatively) be mobile (e.g., a sensor mounted to another vehicle passing by a Mobile AP or Fixed AP, a drone-mounted sensor, a pedestrian-mounted sensor, etc.).

In an example implementation, for example in a controlled space (e.g., a port, harbor, airport, factory, plantation, mine, etc.) with many vehicles, machines and employees, a communication network in accordance with various aspects of the present disclosure may expand the wireless coverage of enterprise and/or local Wi-Fi networks, for example without resorting to a Telco-dependent solution based on SIM cards or cellular fees. In such an example scenario, apart from avoiding expensive cellular data plans, limited data rate (e.g., data throughput rate or effective data transmission rate/speed) and poor cellular coverage in some places, a communication network in accordance with various aspects of the present disclosure is also able to collect and/or communicate large amounts of data, in a reliable and real-time manner, where such data may be used to optimize harbor logistics, transportation operations, etc.

For example in a port and/or harbor implementation, by gathering real-time information on the position, speed, fuel consumption and CO₂ emissions of the vehicles, the communication network allows a port operator to improve the coordination of the ship loading processes and increase the throughput of the harbor. Also for example, the communication network enables remote monitoring of drivers' behaviors, trucks' positions and engines' status, and then be able to provide real-time notifications to drivers (e.g., to turn on/off the engine, follow the right route inside the harbor, take a break, etc.), thus reducing the number and duration of the harbor services and trips. Harbor authorities may, for example, quickly detect malfunctioning trucks and abnormal trucks' circulation, thus avoiding accidents in order to increase harbor efficiency, security, and safety. Additionally, the vehicles can also connect to Wi-Fi access points from harbor local operators, and provide Wi-Fi Internet access to vehicles' occupants and surrounding harbor employees, for example allowing pilots to save time by filing reports via the Internet while still on the water.

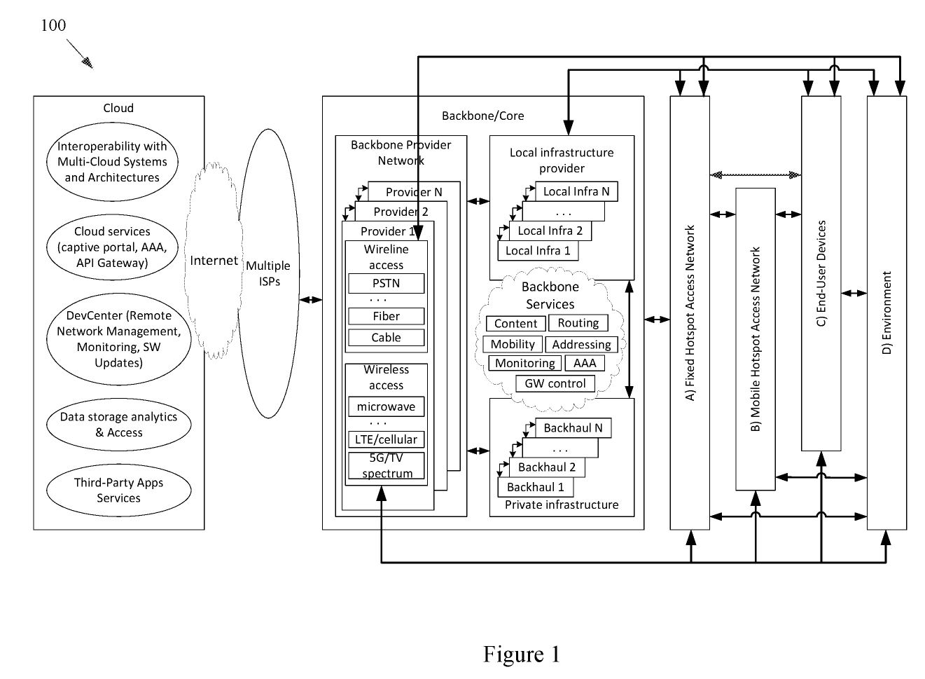

FIG. 1 shows a block diagram of a communication network 100, in accordance with various aspects of this disclosure. Any or all of the functionality discussed herein may be performed by any or all of the example components of the example network 100. Also, the example network 100 may, for example, share any or all characteristics with the other example networks and/or network components 200, 300, 400, 500-570, and 600, discussed herein.

The example network 100, for example, comprises a Cloud that may, for example comprise any of a variety of network level components. The Cloud may, for example, comprise any of a variety of server systems executing applications that monitor and/or control components of the network 100. Such applications may also, for example, manage the collection of information from any of a large array of networked information sources, many examples of which are discussed herein. The Cloud (or a portion thereof) may also be referred to, at times, as an API. For example, Cloud (or a portion thereof) may provide one or more application programming interfaces (APIs) which other devices may use for communicating/interacting with the Cloud.

An example component of the Cloud may, for example, manage interoperability with various multi-cloud systems and architectures. Another example component (e.g., a Cloud service component) may, for example, provide various cloud services (e.g., captive portal services, authentication, authorization, and accounting (AAA) services, API Gateway services, etc.). An additional example component (e.g., a DevCenter component) may, for example, provide network monitoring and/or management functionality, manage the implementation of software updates, etc. A further example component of the Cloud may manage data storage, data analytics, data access, etc. A still further example component of the Cloud may include any of a variety of third-partly applications and services.

The Cloud may, for example, be coupled to the Backbone/Core Infrastructure of the example network 100 via the Internet (e.g., utilizing one or more Internet Service Providers). Though the Internet is provided by example, it should be understood that scope of the present disclosure is not limited thereto.

The Backbone/Core may, for example, comprise any one or more different communication infrastructure components. For example, one or more providers may provide backbone networks or various components thereof. As shown in the example network 100 illustrated in FIG. 1, a Backbone provider may provide wireline access (e.g., PSTN, fiber, cable, etc.). Also for example, a Backbone provider may provide wireless access (e.g., Microwave, LTE/Cellular, 5G/TV Spectrum, etc.).

The Backbone/Core may also, for example, comprise one or more Local Infrastructure Providers. The Backbone/Core may also, for example, comprise a private infrastructure (e.g., run by the network 100 implementer, owner, etc.). The Backbone/Core may, for example, provide any of a variety of Backbone Services (e.g., AAA, Mobility, Monitoring, Addressing, Routing, Content services, Gateway Control services, etc.).

The Backbone/Core Infrastructure may comprise any of a variety of characteristics, non-limiting examples of which are provided herein. For example, the Backbone/Core may be compatible with different wireless or wired technologies for backbone access. The Backbone/Core may also be adaptable to handle public (e.g., municipal, city, campus, etc.) and/or private (e.g., ports, campus, etc.) network infrastructures owned by different local providers, and/or owned by the network implementer or stakeholder. The Backbone/Core may, for example, comprise and/or interface with different Authentication, Authorization, and Accounting (AAA) mechanisms.

The Backbone/Core Infrastructure may, for example, support different modes of operation (e.g., L2 in port implementations, L3 in on-land public transportation implementations, utilizing any one or more of a plurality of different layers of digital IP networking, any combinations thereof, equivalents thereof, etc.) or addressing pools. The Backbone/Core may also for example, be agnostic to the Cloud provider(s) and/or Internet Service Provider(s). Additionally for example, the Backbone/Core may be agnostic to requests coming from any or all subsystems of the network 100 (e.g., Mobile APs or OBUs (On Board Units), Fixed APs or RSUs (Road Side Units), MCs (Mobility Controllers) or LMAs (Local Mobility Anchors) or Network Controllers, etc.) and/or third-party systems.

The Backbone/Core Infrastructure may, for example, comprise the ability to utilize and/or interface with different data storage / processing systems (e.g., MongoDB, MySql, Redis, etc.). The Backbone/Core Infrastructure may further, for example, provide different levels of simultaneous access to the infrastructure, services, data, etc.

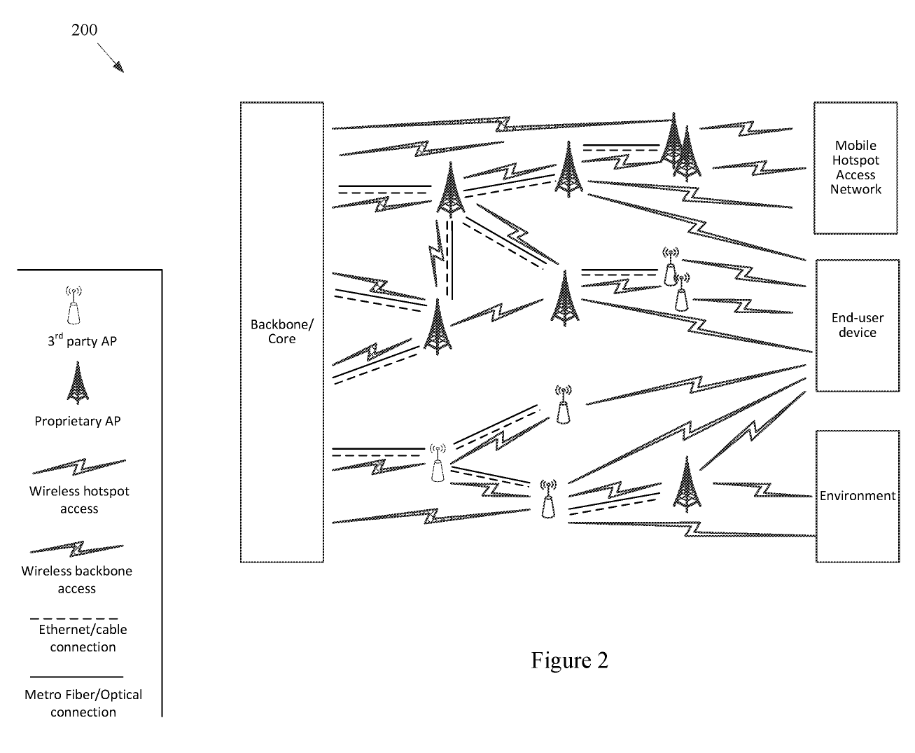

The example network 100 may also, for example, comprise a Fixed Hotspot Access Network. Various example characteristics of such a Fixed Hotspot Access Network 200 are shown at FIG. 2. The example network 200 may, for example, share any or all characteristics with the other example networks and/or network components 100, 300, 400, 500-570, and 600, discussed herein.

In the example network 200, the Fixed APs (e.g., the proprietary APs, the public third party APs, the private third party APs, etc.) may be directly connected to the local infrastructure provider and/or to the wireline/wireless backbone. Also for example, the example network 200 may comprise a mesh between the various APs via wireless technologies. Note, however, that various wired technologies may also be utilized depending on the implementation. As shown, different fixed hotspot access networks can be connected to a same backbone provider, but may also be connected to different respective backbone providers. In an example implementation utilizing wireless technology for backbone access, such an implementation may be relatively fault tolerant. For example, a Fixed AP may utilize wireless communications to the backbone network (e.g., cellular, 3G, LTE, other wide or metropolitan area networks, etc.) if the backhaul infrastructure is down. Also for example, such an implementation may provide for relatively easy installation (e.g., a Fixed AP with no cable power source that can be placed virtually anywhere).

In the example network 200, the same Fixed AP can simultaneously provide access to multiple Fixed APs, Mobile APs (e.g., vehicle OBUs, etc.), devices, user devices, sensors, things, etc. For example, a plurality of mobile hotspot access networks (e.g., OBU-based networks, etc.) may utilize the same Fixed AP. Also for example, the same Fixed AP can provide a plurality of simultaneous accesses to another single unit (e.g., another Fixed AP, Mobile AP, device, etc.), for example utilizing different channels, different radios, etc.).

Note that a plurality of Fixed APs may be utilized for fault-tolerance/fail-recovery purposes. In an example implementation, a Fixed AP and its fail-over AP may both be normally operational (e.g., in a same switch). Also for example, one or more Fixed APs may be placed in the network at various locations in an inactive or monitoring mode, and ready to become operational when needed (e.g., in response to a fault, in response to an emergency services need, in response to a data surge, etc.).

Referring back to FIG. 1, the example Fixed Hotspot Access Network is shown with a wireless communication link to a backbone provider (e.g., to one or more Backbone Providers and/or Local Infrastructure Providers), to a Mobile Hotspot Access Network, to one or more End User Devices, and to the Environment. Also, the example Fixed Hotspot Access Network is shown with a wired communication link to one or more Backbone Providers, to the Mobile Hotspot Access Network, to one or more End User Devices, and to the Environment. The Environment may comprise any of a variety of devices (e.g., in-vehicle networks, devices, and sensors; autonomous vehicle networks, devices, and sensors; maritime (or watercraft) and port networks, devices, and sensors; general controlled-space networks, devices, and sensors; residential networks, devices, and sensors; disaster recovery & emergency networks, devices, and sensors; military and aircraft networks, devices, and sensors; smart city networks, devices, and sensors; event (or venue) networks, devices, and sensors; underwater and underground networks, devices, and sensors; agricultural networks, devices, and sensors; tunnel (auto, subway, train, etc.) networks, devices, and sensors; parking networks, devices, and sensors; security and surveillance networks, devices, and sensors; shipping equipment and container networks, devices, and sensors; environmental control or monitoring networks, devices, and sensors; municipal networks, devices, and sensors; waste management networks, devices, and sensors, road maintenance networks, devices, and sensors, traffic management networks, devices, and sensors; advertising networks, devices and sensors; etc.).

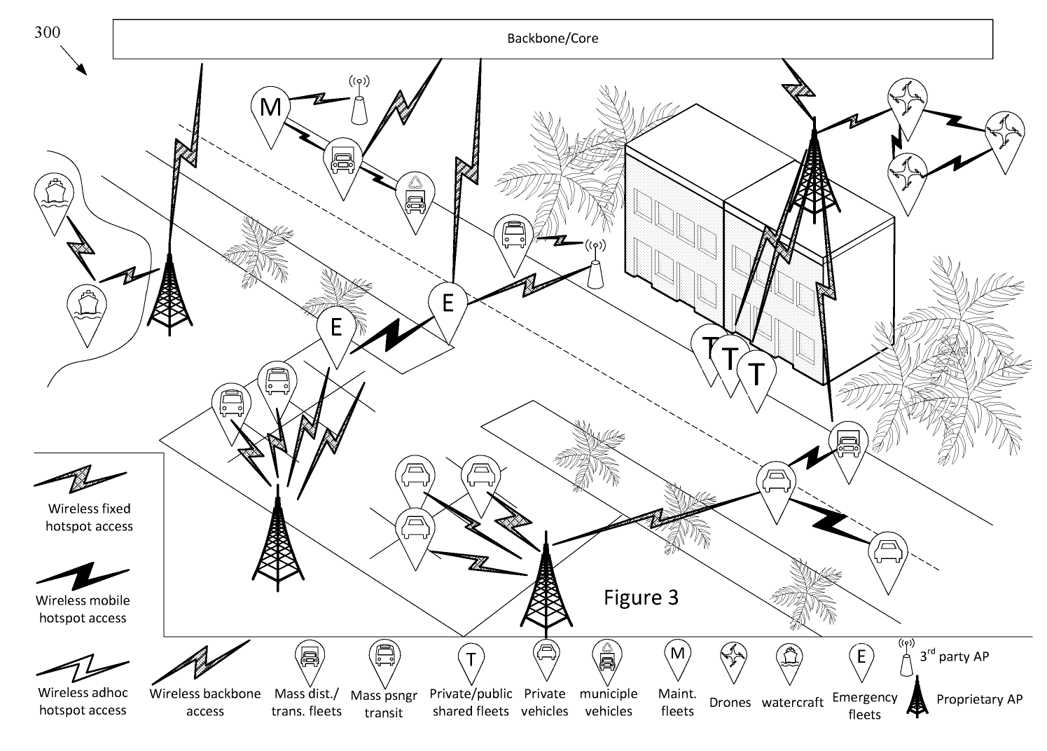

The example network 100 of FIG. 1 also comprises a Mobile Hotspot Access Network. Various example characteristics of such a Mobile Hotspot Access Network 300 are shown at FIG. 3. Note that various fixed network components (e.g., Fixed APs) are also illustrated. The example network 300 may, for example, share any or all characteristics with the other example networks and/or network components 100, 200, 400, 500-570, and 600 discussed herein.

The example network 300 comprises a wide variety of Mobile APs (or hotspots) that provide access to user devices, provide for sensor data collection, provide multi-hop connectivity to other Mobile APs, etc. For example, the example network 300 comprises vehicles from different fleets (e.g., aerial, terrestrial, underground, (under)water, etc.). For example, the example network 300 comprises one or more mass distribution/transportation fleets, one or more mass passenger transportation fleets, private/public shared-user fleets, private vehicles, urban and municipal fleets, maintenance fleets, drones, watercraft (e.g., boats, ships, speedboats, tugboats, barges, etc.), emergency fleets (e.g., police, ambulance, firefighter, etc.), etc.

The example network 300, for example, shows vehicles from different fleets directly connected and/or mesh connected, for example using same or different communication technologies. The example network 300 also shows fleets simultaneously connected to different Fixed APs, which may or may not belong to different respective local infrastructure providers. As a fault-tolerance mechanism, the example network 300 may for example comprise the utilization of long-range wireless communication network (e.g., cellular, 3G, 4G, LTE, etc.) in vehicles if the local network infrastructure is down or otherwise unavailable. A same vehicle (e.g., Mobile AP or OBU) can simultaneously provide access to multiple vehicles, devices, things, etc., for example using a same communication technology (e.g., shared channels and/or different respective channels thereof) and/or using a different respective communication technology for each. Also for example, a same vehicle can provide multiple accesses to another vehicle, device, thing, etc., for example using a same communication technology (e.g., shared channels and/or different respective channels thereof, and/or using a different communication technology).

Additionally, multiple network elements may be connected together to provide for fault-tolerance or fail recovery, increased throughput, or to achieve any or a variety of a client's networking needs, many of examples of which are provided herein. For example, two Mobile APs (or OBUs) may be installed in a same vehicle, etc.

Referring back to FIG. 1, the example Mobile Hotspot Access Network is shown with a wireless communication link to a backbone provider (e.g., to one or more Backbone Providers and/or Local Infrastructure Providers), to a Fixed Hotspot Access Network, to one or more End User Device, and to the Environment (e.g., to any one of more of the sensors or systems discussed herein, any other device or machine, etc.). Though the Mobile Hotspot Access Network is not shown having a wired link to the various other components, there may (at least at times) be such a wired link, at least temporarily.

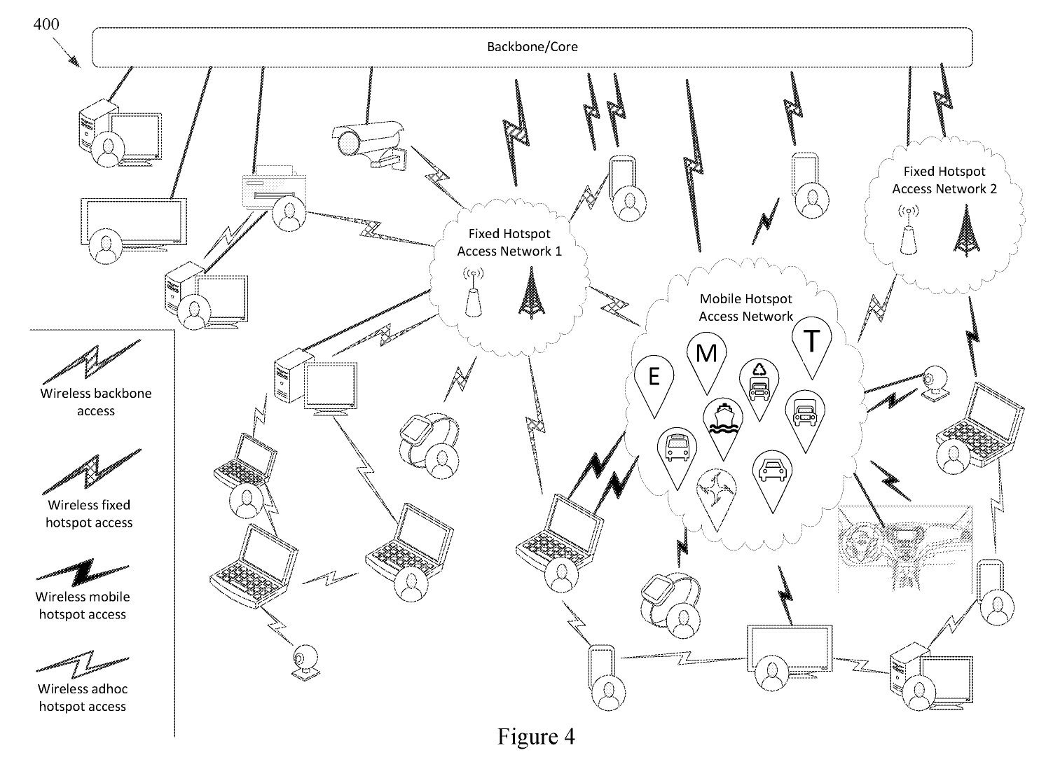

The example network 100 of FIG. 1 also comprises a set of End-User Devices. Various example end user devices are shown at FIG. 4. Note that various other network components (e.g., Fixed Hotspot Access Networks, Mobile Hotspot Access Network(s), the Backbone/Core, etc.) are also illustrated. The example network 400 may, for example, share any or all characteristics with the other example networks and/or network components 100, 200, 300, 500-570, and 600, discussed herein.

The example network 400 shows various mobile networked devices. Such network devices may comprise end-user devices (e.g., smartphones, tablets, smartwatches, laptop computers, webcams, personal gaming devices, personal navigation devices, personal media devices, personal cameras, health-monitoring devices, personal location devices, monitoring panels, printers, etc.). Such networked devices may also comprise any of a variety of devices operating in the general environment, where such devices might not for example be associated with a particular user (e.g. any or all of the sensor devices discussed herein, vehicle sensors, municipal sensors, fleet sensors road sensors, environmental sensors, security sensors, traffic sensors, waste sensors, meteorological sensors, any of a variety of different types of municipal or enterprise equipment, etc.). Any of such networked devices can be flexibly connected to distinct backbone, fixed hotspot access networks, mobile hotspot access networks, etc., using the same or different wired/wireless technologies.

A mobile device may, for example, operate as an AP to provide simultaneous access to multiple devices/things, which may then form ad hoc networks, interconnecting devices ultimately connected to distinct backbone networks, fixed hotspot, and/or mobile hotspot access networks. Devices (e.g., any or all of the devices or network nodes discussed herein) may, for example, have redundant technologies to access distinct backbone, fixed hotspot, and/or mobile hotspot access networks, for example for fault-tolerance and/or load-balancing purposes (e.g., utilizing multiple SIM cards, etc.). A device may also, for example, simultaneously access distinct backbone, fixed hotspot access networks, and/or mobile hotspot access networks, belonging to the same provider or to different respective providers. Additionally for example, a device can provide multiple accesses to another device/thing (e.g., via different channels, radios, etc.).

Referring back to FIG. 1, the example End-User Devices are shown with a wireless communication link to a backbone provider (e.g., to one or more Backbone Providers and/or Local Infrastructure Providers), to a Fixed Hotspot Access Network, to a Mobile Hotspot Access Network, and to the Environment. Also for example, the example End-User Devices are shown with a wired communication link to a backbone provider, to a Fixed Hotspot Access Network, to a Mobile Hotspot Access Network, and to the Environment.

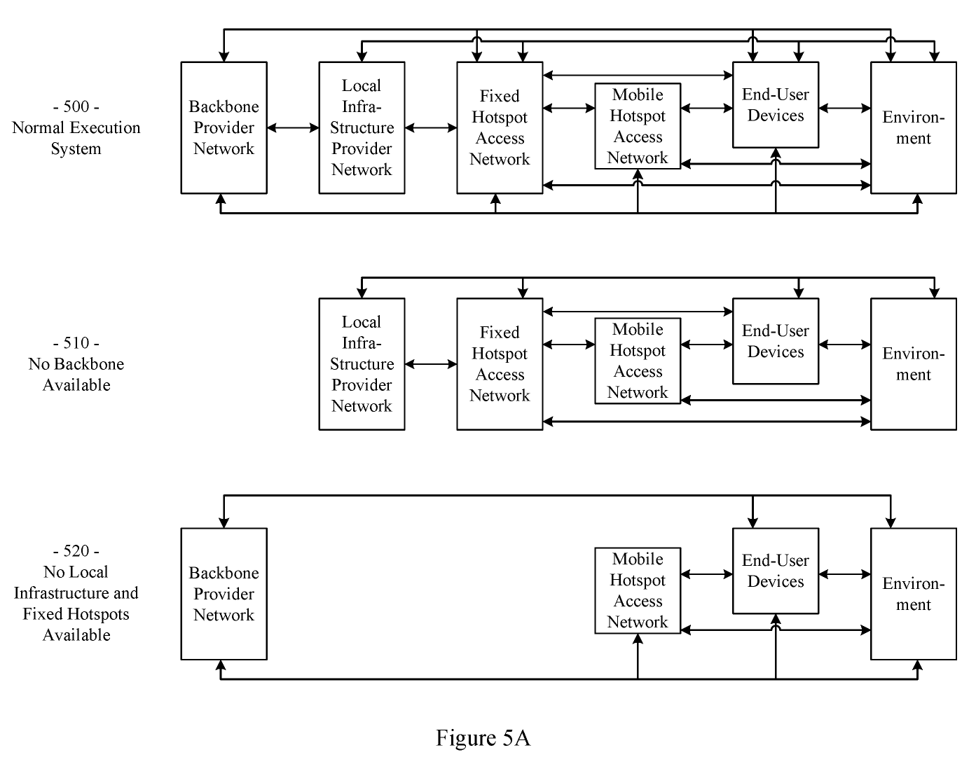

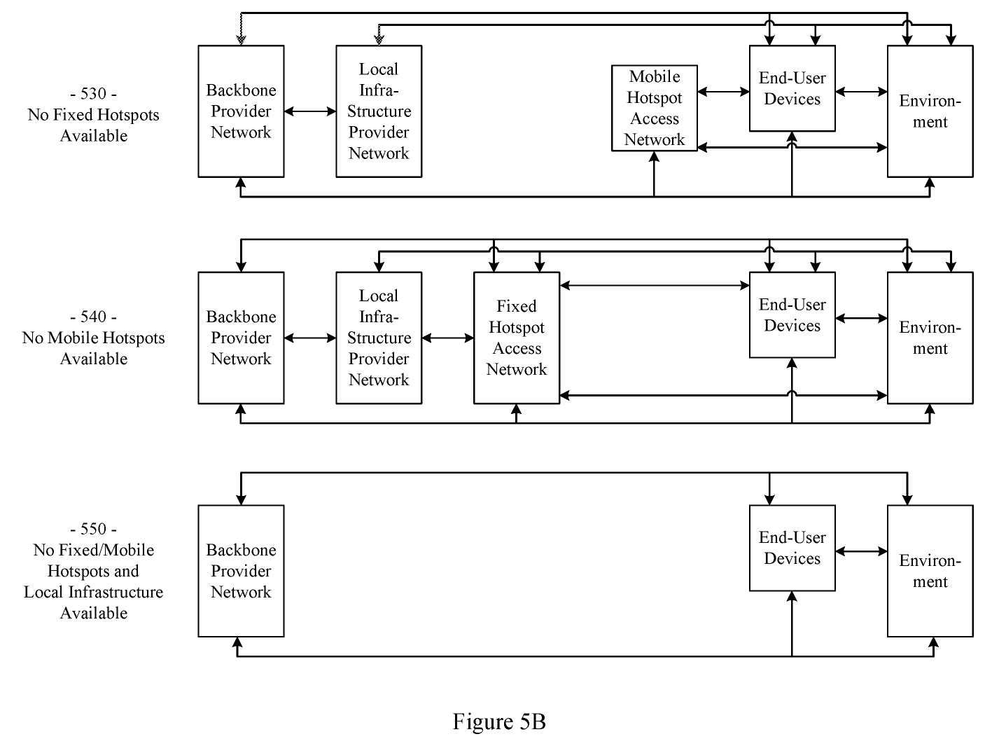

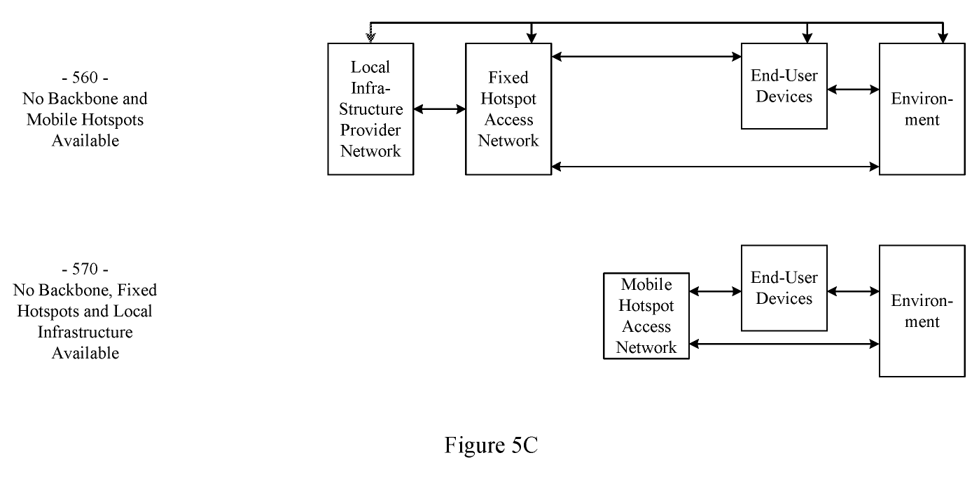

The example network 100 illustrated in FIG. 1 has a flexible architecture that is adaptable at implementation time (e.g., for different use cases) and/or adaptable in real-time, for example as network components enter and leave service. FIGS. 5A-5C illustrate such flexibility by providing example modes (or configurations). The example networks 500-570 may, for example, share any or all characteristics with the other example networks and/or network components 100, 200, 300, 400, and 600, discussed herein. For example and without limitation, any or all of the communication links (e.g., wired links, wireless links, etc.) shown in the example networks 500-570 are generally analogous to similarly positioned communication links shown in the example network 100 of FIG. 1.

For example, various aspects of this disclosure provide communication network architectures, systems, and methods for supporting a dynamically configurable communication network comprising a complex array of both static and moving communication nodes (e.g., the Internet of moving things). For example, a communication network implemented in accordance with various aspects of the present disclosure may operate in one of a plurality of modalities comprising various fixed nodes, mobile nodes, and/or a combination thereof, which are selectable to yield any of a variety of system goals (e.g., increased throughput, reduced latency and packet loss, increased availability and robustness of the system, extra redundancy, increased responsiveness, increased security in the transmission of data and/or control packets, reduced number of configuration changes by incorporating smart thresholds (e.g., change of technology, change of certificate, change of IP, etc.), providing connectivity in dead zones or zones with difficult access, reducing the costs for maintenance and accessing the equipment for updating/upgrading, etc.). At least some of such modalities may, for example, be entirely comprised of fixed-position nodes, at least temporarily if not permanently.

For illustrative simplicity, many of the example aspects shown in the example system or network 100 of FIG. 1 (and other Figures herein) are omitted from FIGS. 5A-5C, but may be present. For example, the Cloud, Internet, and ISP aspects shown in FIG. 1 and in other Figures are not explicitly shown in FIGS. 5A-5C, but may be present in any of the example configurations (e.g., as part of the backbone provider network or coupled thereto, as part of the local infrastructure provider network or coupled thereto, etc.).

For example, the first example mode 500 is presented as a normal execution mode, for example a mode (or configuration) in which all of the components discussed herein are present. For example, the communication system in the first example mode 500 comprises a backbone provider network, a local infrastructure provider network, a fixed hotspot access network, a mobile hotspot access network, end-user devices, and environment devices.

As shown in FIG. 5A, and in FIG. 1 in more detail, the backbone provider network may be communicatively coupled to any or all of the other elements present in the first example mode 500 (or configuration) via one or more wired (or tethered) links. For example, the backbone provider network may be communicatively coupled to the local infrastructure provider network (or any component thereof), fixed hotspot access network (or any component thereof), the end-user devices, and/or environment devices via a wired link. Note that such a wired coupling may be temporary. Also note that in various example configurations, the backbone provider network may also, at least temporarily, be communicatively coupled to the mobile hotspot access network (or any component thereof) via one or more wired (or tethered) links.

Also shown in FIG. 5A, and in FIG. 1 in more detail, the backbone provider network may be communicatively coupled to any or all of the other elements present in the first example mode 500 (or configuration) via one or more wireless links (e.g., RF link, non-tethered optical link, etc.). For example, the backbone provider network may be communicatively coupled to the fixed hotspot access network (or any component thereof), the mobile hotspot access network (or any component thereof), the end-user devices, and/or environment devices via one or more wireless links. Also note that in various example configurations, the backbone provider network may also be communicatively coupled to the local infrastructure provider network via one or more wireless (or non-tethered) links.

Though not shown in the first example mode 500 (or any of the example modes of FIGS. 5A-5C), one or more servers may be communicatively coupled to the backbone provider network and/or the local infrastructure network. FIG. 1 provides an example of cloud servers being communicatively coupled to the backbone provider network via the Internet.

As additionally shown in FIG. 5A, and in FIG. 1 in more detail, the local infrastructure provider network may be communicatively coupled to any or all of the other elements present in the first example mode 500 (or configuration) via one or more wired (or tethered) links. For example, the local infrastructure provider network may be communicatively coupled to the backbone provider network (or any component thereof), fixed hotspot access network (or any component thereof), the end-user devices, and/or environment devices via one or more wired links. Note that such a wired coupling may be temporary. Also note that in various example configurations, the local infrastructure provider network may also, at least temporarily, be communicatively coupled to the mobile hotspot access network (or any component thereof) via one or more wired (or tethered) links.

Also, though not explicitly shown, the local infrastructure provider network may be communicatively coupled to any or all of the other elements present in the first example mode 500 (or configuration) via one or more wireless links (e.g., RF link, non-tethered optical link, etc.). For example, the local infrastructure provider network may be communicatively coupled to the backbone provider network (or any component thereof), the fixed hotspot access network (or any component thereof), the mobile hotspot access network (or any component thereof), the end-user devices, and/or environment devices via one or more wireless links. Note that the communication link shown in the first example mode 500 of FIG. 5A between the local infrastructure provider network and the fixed hotspot access network may be wired and/or wireless.

The fixed hotspot access network is also shown in the first example mode 500 to be communicatively coupled to the mobile hotspot access network, the end-user devices, and/or environment devices via one or more wireless links. Many examples of such wireless coupling are provided herein. Additionally, the mobile hotspot access network is further shown in the first example mode 500 to be communicatively coupled to the end-user devices and/or environment devices via one or more wireless links. Many examples of such wireless coupling are provided herein. Further, the end-user devices are also shown in the first example mode 500 to be communicatively coupled to the environment devices via one or more wireless links. Many examples of such wireless coupling are provided herein. Note that in various example implementations any of such wireless links may instead (or in addition) comprise a wired (or tethered) link.

In the first example mode 500 (e.g., the normal mode), information (or data) may be communicated between an end-user device and a server (e.g., a computer system) via the mobile hotspot access network, the fixed hotspot access network, the local infrastructure provider network, and/or the backbone provider network. As will be seen in the various example modes presented herein, such communication may flexibly occur between an end-user device and a server via any of a variety of different communication pathways, for example depending on the availability of a network, depending on bandwidth utilization goals, depending on communication priority, depending on communication time (or latency) and/or reliability constraints, depending on cost, etc. For example, information communicated between an end user device and a server may be communicated via the fixed hotspot access network, the local infrastructure provider network, and/or the backbone provider network (e.g., skipping the mobile hotspot access network). Also for example, information communicated between an end user device and a server may be communicated via the backbone provider network (e.g., skipping the mobile hotspot access network, fixed hotspot access network, and/or local infrastructure provider network).

Similarly, in the first example mode 500 (e.g., the normal mode), information (or data) may be communicated between an environment device and a server via the mobile hotspot access network, the fixed hotspot access network, the local infrastructure provider network, and/or the backbone provider network. Also for example, an environment device may communicate with or through an end-user device (e.g., instead of or in addition to the mobile hotspot access network). As will be seen in the various example modes presented herein, such communication may flexibly occur between an environment device and a server (e.g., communicatively coupled to the local infrastructure provider network and/or backbone provider network) via any of a variety of different communication pathways, for example depending on the availability of a network, depending on bandwidth utilization goals, depending on communication priority, depending on communication time (or latency) and/or reliability constraints, depending on cost, etc.

For example, information communicated between an environment device and a server may be communicated via the fixed hotspot access network, the local infrastructure provider network, and/or the backbone provider network (e.g., skipping the mobile hotspot access network). Also for example, information communicated between an environment device and a server may be communicated via the backbone provider network (e.g., skipping the mobile hotspot access network, fixed hotspot access network, and/or local infrastructure provider network). Additionally for example, information communicated between an environment device and a server may be communicated via the local infrastructure provider network (e.g., skipping the mobile hotspot access network and/or fixed hotspot access network).

As discussed herein, the example networks presented herein are adaptively configurable to operate in any of a variety of different modes (or configurations). Such adaptive configuration may occur at initial installation and/or during subsequent controlled network evolution (e.g., adding or removing any or all of the network components discussed herein, expanding or removing network capacity, adding or removing coverage areas, adding or removing services, etc.). Such adaptive configuration may also occur in real-time, for example in response to real-time changes in network conditions (e.g., networks or components thereof being available or not based on vehicle or user-device movement, network or component failure, network or component replacement or augmentation activity, network overloading, etc.). The following example modes are presented to illustrate characteristics of various modes in which a communication system may operate in accordance with various aspects of the present disclosure. The following example modes will generally be discussed in relation to the first example mode 500 (e.g., the normal execution mode). Note that such example modes are merely illustrative and not limiting.

The second example mode (or configuration) 510 (e.g., a no backbone available mode) may, for example, share any or all characteristics with the first example mode 500, albeit without the backbone provider network and communication links therewith. For example, the communication system in the second example mode 510 comprises a local infrastructure provider network, a fixed hotspot access network, a mobile hotspot access network, end-user devices, and environment devices.

As shown in FIG. 5A, and in FIG. 1 in more detail, the local infrastructure provider network may be communicatively coupled to any or all of the other elements present in the second example mode 510 (or configuration) via one or more wired (or tethered) links. For example, the local infrastructure provider network may be communicatively coupled to the fixed hotspot access network (or any component thereof), the end-user devices, and/or environment devices via one or more wired links. Note that such a wired coupling may be temporary. Also note that in various example configurations, the local infrastructure provider network may also, at least temporarily, be communicatively coupled to the mobile hotspot access network (or any component thereof) via one or more wired (or tethered) links.

Also, though not explicitly shown, the local infrastructure provider network may be communicatively coupled to any or all of the other elements present in the second example mode 510 (or configuration) via one or more wireless links (e.g., RF link, non-tethered optical link, etc.). For example, the local infrastructure provider network may be communicatively coupled to the fixed hotspot access network (or any component thereof), the mobile hotspot access network (or any component thereof), the end-user devices, and/or environment devices via one or more wireless links. Note that the communication link(s) shown in the second example mode 510 of FIG. 5A between the local infrastructure provider network and the fixed hotspot access network may be wired and/or wireless.

The fixed hotspot access network is also shown in the second example mode 510 to be communicatively coupled to the mobile hotspot access network, the end-user devices, and/or environment devices via one or more wireless links. Many examples of such wireless coupling are provided herein. Additionally, the mobile hotspot access network is further shown in the second example mode 510 to be communicatively coupled to the end-user devices and/or environment devices via one or more wireless links. Many examples of such wireless coupling are provided herein. Further, the end-user devices are also shown in the second example mode 510 to be communicatively coupled to the environment devices via one or more wireless links. Many examples of such wireless coupling are provided herein. Note that in various example implementations any of such wireless links may instead (or in addition) comprise a wired (or tethered) link.

In the second example mode 510 (e.g., the no backbone available mode), information (or data) may be communicated between an end-user device and a server (e.g., a computer, etc.) via the mobile hotspot access network, the fixed hotspot access network, and/or the local infrastructure provider network. As will be seen in the various example modes presented herein, such communication may flexibly occur between an end-user device and a server via any of a variety of different communication pathways, for example depending on the availability of a network, depending on bandwidth utilization goals, depending on communication priority, depending on communication time (or latency) and/or reliability constraints, depending on cost, etc. For example, information communicated between an end user device and a server may be communicated via the fixed hotspot access network and/or the local infrastructure provider network (e.g., skipping the mobile hotspot access network). Also for example, information communicated between an end user device and a server may be communicated via the local infrastructure provider network (e.g., skipping the mobile hotspot access network and/or fixed hotspot access network).

Similarly, in the second example mode 510 (e.g., the no backbone available mode), information (or data) may be communicated between an environment device and a server via the mobile hotspot access network, the fixed hotspot access network, and/or the local infrastructure provider network. Also for example, an environment device may communicate with or through an end-user device (e.g., instead of or in addition to the mobile hotspot access network). As will be seen in the various example modes presented herein, such communication may flexibly occur between an environment device and a server (e.g., communicatively coupled to the local infrastructure provider network) via any of a variety of different communication pathways, for example depending on the availability of a network, depending on bandwidth utilization goals, depending on communication priority, depending on communication time (or latency) and/or reliability constraints, depending on cost, etc.

For example, information communicated between an environment device and a server may be communicated via the fixed hotspot access network and/or the local infrastructure provider network (e.g., skipping the mobile hotspot access network). Also for example, information communicated between an environment device and a server may be communicated via the local infrastructure provider network (e.g., skipping the mobile hotspot access network and/or fixed hotspot access network).

The second example mode 510 may be utilized for any of a variety of reasons, non-limiting examples of which are provided herein. For example, due to security and/or privacy goals, the second example mode 510 may be utilized so that communication access to the public Cloud systems, the Internet in general, etc., is not allowed. For example, all network control and management functions may be within the local infrastructure provider network (e.g., wired local network, etc.) and/or the fixed access point network.

In an example implementation, the communication system might be totally owned, operated and/or controlled by a local port authority. No extra expenses associated with cellular connections need be spent. For example, cellular connection capability (e.g., in Mobile APs, Fixed APs, end user devices, environment devices, etc.) need not be provided. Note also that the second example mode 510 may be utilized in a scenario in which the backbone provider network is normally available but is currently unavailable (e.g., due to server failure, due to communication link failure, due to power outage, due to a temporary denial of service, etc.).

The third example mode (or configuration) 520 (e.g., a no local infrastructure and fixed hotspots available mode) may, for example, share any or all characteristics with the first example mode 500, albeit without the local infrastructure provider network, the fixed hotspot access network, and communication links therewith. For example, the communication system in the third example mode 520 comprises a backbone provider network, a mobile hotspot access network, end-user devices, and environment devices.

As shown in FIG. 5A, and in FIG. 1 in more detail, the backbone provider network may be communicatively coupled to any or all of the other elements present in the third example mode 520 (or configuration) via one or more wired (or tethered) links. For example, the backbone provider network may be communicatively coupled to the end-user devices and/or environment devices via one or more wired links. Note that such a wired coupling may be temporary. Also note that in various example configurations, the backbone provider network may also, at least temporarily, be communicatively coupled to the mobile hotspot access network (or any component thereof) via one or more wired (or tethered) links.

Also shown in FIG. 5A, and in FIG. 1 in more detail, the backbone provider network may be communicatively coupled to any or all of the other elements present in the third example mode 520 (or configuration) via one or more wireless links (e.g., RF link, non-tethered optical link, etc.). For example, the backbone provider network may be communicatively coupled to the mobile hotspot access network (or any component thereof), the end-user devices, and/or environment devices via one or more wireless links.

The mobile hotspot access network is further shown in the third example mode 520 to be communicatively coupled to the end-user devices and/or environment devices via one or more wireless links. Many examples of such wireless coupling are provided herein. Further, the end-user devices are also shown in the third example mode 520 to be communicatively coupled to the environment devices via one or more wireless links. Many examples of such wireless coupling are provided herein. Note that in various example implementations any of such wireless links may instead (or in addition) comprise a wired (or tethered) link.

In the third example mode 520 (e.g., the no local infrastructure and fixed hotspots available mode), information (or data) may be communicated between an end-user device and a server (e.g., a computer, etc.) via the mobile hotspot access network and/or the backbone provider network. As will be seen in the various example modes presented herein, such communication may flexibly occur between an end-user device and a server via any of a variety of different communication pathways, for example depending on the availability of a network, depending on bandwidth utilization goals, depending on communication priority, depending on communication time (or latency) and/or reliability constraints, depending on cost, etc. For example, information communicated between an end user device and a server may be communicated via the backbone provider network (e.g., skipping the mobile hotspot access network).

Similarly, in the third example mode 520 (e.g., the no local infrastructure and fixed hotspots available mode), information (or data) may be communicated between an environment device and a server via the mobile hotspot access network and/or the backbone provider network. Also for example, an environment device may communicate with or through an end-user device (e.g., instead of or in addition to the mobile hotspot access network). As will be seen in the various example modes presented herein, such communication may flexibly occur between an environment device and a server (e.g., communicatively coupled to the backbone provider network) via any of a variety of different communication pathways, for example depending on the availability of a network, depending on bandwidth utilization goals, depending on communication priority, depending on communication time (or latency) and/or reliability constraints, depending on cost, etc. For example, information communicated between an environment device and a server may be communicated via the backbone provider network (e.g., skipping the mobile hotspot access network).

In the third example mode 520, all control/management functions may for example be implemented within the Cloud. For example, since the mobile hotspot access network does not have a communication link via a fixed hotspot access network, the Mobile APs may utilize a direct connection (e.g., a cellular connection) with the backbone provider network (or Cloud). If a Mobile AP does not have such capability, the Mobile AP may also, for example, utilize data access provided by the end-user devices communicatively coupled thereto (e.g., leveraging the data plans of the end-user devices).

The third example mode 520 may be utilized for any of a variety of reasons, non-limiting examples of which are provided herein. In an example implementation, the third example mode 520 may be utilized in an early stage of a larger deployment, for example deployment that will grow into another mode (e.g., the example first mode 500, example fourth mode 530, etc.) as more communication system equipment is installed. Note also that the third example mode 520 may be utilized in a scenario in which the local infrastructure provider network and fixed hotspot access network are normally available but are currently unavailable (e.g., due to equipment failure, due to communication link failure, due to power outage, due to a temporary denial of service, etc.).

The fourth example mode (or configuration) 530 (e.g., a no fixed hotspots available mode) may, for example, share any or all characteristics with the first example mode 500, albeit without the fixed hotspot access network and communication links therewith. For example, the communication system in the fourth example mode 530 comprises a backbone provider network, a local infrastructure provider network, a mobile hotspot access network, end-user devices, and environment devices.

As shown in FIG. 5B, and in FIG. 1 in more detail, the backbone provider network may be communicatively coupled to any or all of the other elements present in the fourth example mode 530 (or configuration) via one or more wired (or tethered) links. For example, the backbone provider network may be communicatively coupled to the local infrastructure provider network (or any component thereof), the end-user devices, and/or environment devices via one or more wired links. Note that such a wired coupling may be temporary. Also note that in various example configurations, the backbone provider network may also, at least temporarily, be communicatively coupled to the mobile hotspot access network (or any component thereof) via one or more wired (or tethered) links.

Also shown in FIG. 5B, and in FIG. 1 in more detail, the backbone provider network may be communicatively coupled to any or all of the other elements present in the fourth example mode 530 (or configuration) via one or more wireless links (e.g., RF link, non-tethered optical link, etc.). For example, the backbone provider network may be communicatively coupled to the mobile hotspot access network (or any component thereof), the end-user devices, and/or environment devices via one or more wireless links. Also note that in various example configurations, the backbone provider network may also be communicatively coupled to the local infrastructure provider network via one or more wireless (or non-tethered) links.

As additionally shown in FIG. 5B, and in FIG. 1 in more detail, the local infrastructure provider network may be communicatively coupled to any or all of the other elements present in the fourth example mode 530 (or configuration) via one or more wired (or tethered) links. For example, the local infrastructure provider network may be communicatively coupled to the backbone provider network (or any component thereof), the end-user devices, and/or environment devices via one or more wired links. Note that such a wired coupling may be temporary. Also note that in various example configurations, the local infrastructure provider network may also, at least temporarily, be communicatively coupled to the mobile hotspot access network (or any component thereof) via one or more wired (or tethered) links.

Also, though not explicitly shown, the local infrastructure provider network may be communicatively coupled to any or all of the other elements present in the fourth example mode 530 (or configuration) via one or more wireless links (e.g., RF link, non-tethered optical link, etc.). For example, the local infrastructure provider network may be communicatively coupled to the backbone provider network (or any component thereof), the mobile hotspot access network (or any component thereof), the end-user devices, and/or environment devices via one or more wireless links.

The mobile hotspot access network is further shown in the fourth example mode 530 to be communicatively coupled to the end-user devices and/or environment devices via one or more wireless links. Many examples of such wireless coupling are provided herein. Further, the end-user devices are also shown in the fourth example mode 530 to be communicatively coupled to the environment devices via one or more wireless links. Many examples of such wireless coupling are provided herein.

In the fourth example mode 530 (e.g., the no fixed hotspots mode), information (or data) may be communicated between an end-user device and a server via the mobile hotspot access network, the local infrastructure provider network, and/or the backbone provider network. As will be seen in the various example modes presented herein, such communication may flexibly occur between an end-user device and a server via any of a variety of different communication pathways, for example depending on the availability of a network, depending on bandwidth utilization goals, depending on communication priority, depending on communication time (or latency) and/or reliability constraints, depending on cost, etc. For example, information communicated between an end user device and a server may be communicated via the local infrastructure provider network and/or the backbone provider network (e.g., skipping the mobile hotspot access network). Also for example, information communicated between an end user device and a server may be communicated via the backbone provider network (e.g., skipping the mobile hotspot access network and/or local infrastructure provider network).

Similarly, in the fourth example mode 530 (e.g., the no fixed hotspots available mode), information (or data) may be communicated between an environment device and a server via the mobile hotspot access network, the local infrastructure provider network, and/or the backbone provider network. Also for example, an environment device may communicate with or through an end-user device (e.g., instead of or in addition to the mobile hotspot access network). As will be seen in the various example modes presented herein, such communication may flexibly occur between an environment device and a server (e.g., communicatively coupled to the local infrastructure provider network and/or backbone provider network) via any of a variety of different communication pathways, for example depending on the availability of a network, depending on bandwidth utilization goals, depending on communication priority, depending on communication time (or latency) and/or reliability constraints, depending on cost, etc.

For example, information communicated between an environment device and a server may be communicated via the local infrastructure provider network and/or the backbone provider network (e.g., skipping the mobile hotspot access network). Also for example, information communicated between an environment device and a server may be communicated via the backbone provider network (e.g., skipping the mobile hotspot access network and/or local infrastructure provider network). Additionally for example, information communicated between an environment device and a server may be communicated via the local infrastructure provider network (e.g., skipping the mobile hotspot access network and/or backbone provider network).

In the fourth example mode 530, in an example implementation, some of the control/management functions may for example be implemented within the local backbone provider network (e.g., within a client premises). For example, communication to the local infrastructure provider may be performed through the backbone provider network (or Cloud). Note that in a scenario in which there is a direct communication pathway between the local infrastructure provider network and the mobile hotspot access network, such communication pathway may be utilized.

For example, since the mobile hotspot access network does not have a communication link via a fixed hotspot access network, the Mobile APs may utilize a direct connection (e.g., a cellular connection) with the backbone provider network (or Cloud). If a Mobile AP does not have such capability, the Mobile AP may also, for example, utilize data access provided by the end-user devices communicatively coupled thereto (e.g., leveraging the data plans of the end-user devices).

The fourth example mode 530 may be utilized for any of a variety of reasons, non-limiting examples of which are provided herein. In an example implementation, the fourth example mode 530 may be utilized in an early stage of a larger deployment, for example a deployment that will grow into another mode (e.g., the example first mode 500, etc.) as more communication system equipment is installed. The fourth example mode 530 may, for example, be utilized in a scenario in which there is no fiber (or other) connection available for Fixed APs (e.g., in a maritime scenario, in a plantation scenario, etc.), or in which a Fixed AP is difficult to access or connect. For example, one or more Mobile APs of the mobile hotspot access network may be used as gateways to reach the Cloud. The fourth example mode 530 may also, for example, be utilized when a vehicle fleet and/or the Mobile APs associated therewith are owned by a first entity and the Fixed APs are owned by another entity, and there is no present agreement for communication between the Mobile APs and the Fixed APs. Note also that the fourth example mode 530 may be utilized in a scenario in which the fixed hotspot access network is normally available but are currently unavailable (e.g., due to equipment failure, due to communication link failure, due to power outage, due to a temporary denial of service, etc.).

The fifth example mode (or configuration) 540 (e.g., a no mobile hotspots available mode) may, for example, share any or all characteristics with the first example mode 500, albeit without the mobile hotspot access network and communication links therewith. For example, the communication system in the fifth example mode 540 comprises a backbone provider network, a local infrastructure provider network, a fixed hotspot access network, end-user devices, and environment devices.

As shown in FIG. 5B, and in FIG. 1 in more detail, the backbone provider network may be communicatively coupled to any or all of the other elements present in the fifth example mode 540 (or configuration) via one or more wired (or tethered) links. For example, the backbone provider network may be communicatively coupled to the local infrastructure provider network (or any component thereof), fixed hotspot access network (or any component thereof), the end-user devices, and/or environment devices via one or more wired links. Note that such a wired coupling may be temporary.

Also shown in FIG. 5B, and in FIG. 1 in more detail, the backbone provider network may be communicatively coupled to any or all of the other elements present in the fifth example mode 540 (or configuration) via one or more wireless links (e.g., RF link, non-tethered optical link, etc.). For example, the backbone provider network may be communicatively coupled to the fixed hotspot access network (or any component thereof), the end-user devices, and/or environment devices via one or more wireless links. Also note that in various example configurations, the backbone provider network may also be communicatively coupled to the local infrastructure provider network via one or more wireless (or non-tethered) links.

As additionally shown in FIG. 5B, and in FIG. 1 in more detail, the local infrastructure provider network may be communicatively coupled to any or all of the other elements present in the fifth example mode 540 (or configuration) via one or more wired (or tethered) links. For example, the local infrastructure provider network may be communicatively coupled to the backbone provider network (or any component thereof), fixed hotspot access network (or any component thereof), the end-user devices, and/or environment devices via one or more wired links. Note that such a wired coupling may be temporary. Also note that in various example configurations, the local infrastructure provider network may also, at least temporarily, be communicatively coupled to the mobile hotspot access network (or any component thereof) via one or more wired (or tethered) links.

Also, though not explicitly shown, the local infrastructure provider network may be communicatively coupled to any or all of the other elements present in the fifth example mode 540 (or configuration) via one or more wireless links (e.g., RF link, non-tethered optical link, etc.). For example, the local infrastructure provider network may be communicatively coupled to the backbone provider network, the fixed hotspot access network (or any component thereof), the end-user devices, and/or environment devices via one or more wireless links. Note that the communication link(s) shown in the fifth example mode 540 of FIG. 5B between the local infrastructure provider network and the fixed hotspot access network may be wired and/or wireless.

The fixed hotspot access network is also shown in the fifth example mode 540 to be communicatively coupled to the end-user devices and/or environment devices via one or more wireless links. Many examples of such wireless coupling are provided herein. Further, the end-user devices are also shown in the fifth example mode 540 to be communicatively coupled to the environment devices via one or more wireless links. Many examples of such wireless coupling are provided herein.

In the fifth example mode 540 (e.g., the no mobile hotspots available mode), information (or data) may be communicated between an end-user device and a server via the fixed hotspot access network, the local infrastructure provider network, and/or the backbone provider network. As will be seen in the various example modes presented herein, such communication may flexibly occur between an end-user device and a server via any of a variety of different communication pathways, for example depending on the availability of a network, depending on bandwidth utilization goals, depending on communication priority, depending on communication time (or latency) and/or reliability constraints, depending on cost, etc. For example, information communicated between an end user device and a server may be communicated via the local infrastructure provider network, and/or the backbone provider network (e.g., skipping the fixed hotspot access network). Also for example, information communicated between an end user device and a server may be communicated via the backbone provider network (e.g., skipping the fixed hotspot access network and/or local infrastructure provider network).

Similarly, in the fifth example mode 540 (e.g., the no mobile hotspots available mode), information (or data) may be communicated between an environment device and a server via the fixed hotspot access network, the local infrastructure provider network, and/or the backbone provider network. Also for example, an environment device may communicate with or through an end-user device (e.g., instead of or in addition to the fixed hotspot access network). As will be seen in the various example modes presented herein, such communication may flexibly occur between an environment device and a server (e.g., communicatively coupled to the local infrastructure provider network and/or backbone provider network) via any of a variety of different communication pathways, for example depending on the availability of a network, depending on bandwidth utilization goals, depending on communication priority, depending on communication time (or latency) and/or reliability constraints, depending on cost, etc.

For example, information communicated between an environment device and a server may be communicated via the local infrastructure provider network and/or the backbone provider network (e.g., skipping the fixed hotspot access network). Also for example, information communicated between an environment device and a server may be communicated via the backbone provider network (e.g., skipping the fixed hotspot access network and/or local infrastructure provider network). Additionally for example, information communicated between an environment device and a server may be communicated via the local infrastructure provider network (e.g., skipping the fixed hotspot access network and/or the backbone provider network).

In the fifth example mode 540, in an example implementation, the end-user devices and environment devices may communicate directly to Fixed APs (e.g., utilizing Ethernet, Wi-Fi, etc.). Also for example, the end-user devices and/or environment devices may communicate directly with the backbone provider network (e.g., utilizing cellular connections, etc.).

The fifth example mode 540 may be utilized for any of a variety of reasons, non-limiting examples of which are provided herein. In an example implementation in which end-user devices and/or environment devices may communicate directly with Fixed APs, such communication may be utilized instead of Mobile AP communication. For example, the fixed hotspot access network might provide coverage for all desired areas.

Note also that the fifth example mode 540 may be utilized in a scenario in which the fixed hotspot access network is normally available but is currently unavailable (e.g., due to equipment failure, due to communication link failure, due to power outage, due to a temporary denial of service, etc.).

The sixth example mode (or configuration) 550 (e.g., the no fixed/mobile hotspots and local infrastructure available mode) may, for example, share any or all characteristics with the first example mode 500, albeit without the local infrastructure provider network, fixed hotspot access network, mobile hotspot access network, and communication links therewith. For example, the communication system in the sixth example mode 550 comprises a backbone provider network, end-user devices, and environment devices.

As shown in FIG. 5B, and in FIG. 1 in more detail, the backbone provider network may be communicatively coupled to any or all of the other elements present in the sixth example mode 550 (or configuration) via one or more wired (or tethered) links. For example, the backbone provider network may be communicatively coupled to the end-user devices and/or environment devices via one or more wired links. Note that such a wired coupling may be temporary.

Also shown in FIG. 5B, and in FIG. 1 in more detail, the backbone provider network may be communicatively coupled to any or all of the other elements present in the sixth example mode 550 (or configuration) via one or more wireless links (e.g., RF link, non-tethered optical link, etc.). For example, the backbone provider network may be communicatively coupled to the end-user devices and/or environment devices via one or more wireless links.

The end-user devices are also shown in the sixth example mode 550 to be communicatively coupled to the environment devices via one or more wireless links. Many examples of such wireless coupling are provided herein.

In the sixth example mode 550 (e.g., the no fixed/mobile hotspots and local infrastructure available mode), information (or data) may be communicated between an end-user device and a server via the backbone provider network. Similarly, in the sixth example mode 550 (e.g., the no fixed/mobile hotspots and local infrastructure mode), information (or data) may be communicated between an environment device and a server via the backbone provider network. Also for example, an environment device may communicate with or through an end-user device (e.g., instead of or in addition to the mobile hotspot access network).

The sixth example mode 550 may be utilized for any of a variety of reasons, non-limiting examples of which are provided herein. In an example implementation, for example in which an end-user has not yet subscribed to the communication system, the end-user device may subscribe to the system through a Cloud application and by communicating directly with the backbone provider network (e.g., via cellular link, etc.). The sixth example mode 550 may also, for example, be utilized in rural areas in which Mobile AP presence is sparse, Fixed AP installation is difficult or impractical, etc.

Note also that the sixth example mode 550 may be utilized in a scenario in which the infrastructure provider network, fixed hotspot access network, and/or mobile hotspot access network are normally available but are currently unavailable (e.g., due to equipment failure, due to communication link failure, due to power outage, due to a temporary denial of service, etc.).

The seventh example mode (or configuration) 560 (e.g., the no backbone and mobile hotspots available mode) may, for example, share any or all characteristics with the first example mode 500, albeit without the backbone provider network, mobile hotspot access network, and communication links therewith. For example, the communication system in the seventh example mode 560 comprises a local infrastructure provider network, fixed hotspot access network, end-user devices, and environment devices.

As shown in FIG. 5C, and in FIG. 1 in more detail, the local infrastructure provider network may be communicatively coupled to any or all of the other elements present in the seventh example mode 560 (or configuration) via one or more wired (or tethered) links. For example, the local infrastructure provider network may be communicatively coupled to the fixed hotspot access network (or any component thereof), the end-user devices, and/or environment devices via one or more wired links. Note that such a wired coupling may be temporary.

Also, though not explicitly shown, the local infrastructure provider network may be communicatively coupled to any or all of the other elements present in the seventh example mode 560 (or configuration) via one or more wireless links (e.g., RF link, non-tethered optical link, etc.). For example, the local infrastructure provider network may be communicatively coupled to the fixed hotspot access network (or any component thereof), the end-user devices, and/or environment devices via one or more wireless links. Note that the communication link shown in the seventh example mode 560 of FIG. 5C between the local infrastructure provider network and the fixed hotspot access network may be wired and/or wireless.

The fixed hotspot access network is also shown in the seventh example mode 560 to be communicatively coupled to the end-user devices and/or environment devices via one or more wireless links. Many examples of such wireless coupling are provided herein. Additionally, the end-user devices are also shown in the seventh example mode 560 to be communicatively coupled to the environment devices via one or more wireless links. Many examples of such wireless coupling are provided herein.

In the seventh example mode 560 (e.g., the no backbone and mobile hotspots available mode), information (or data) may be communicated between an end-user device and a server via the fixed hotspot access network and/or the local infrastructure provider network. As will be seen in the various example modes presented herein, such communication may flexibly occur between an end-user device and a server via any of a variety of different communication pathways, for example depending on the availability of a network, depending on bandwidth utilization goals, depending on communication priority, depending on communication time (or latency) and/or reliability constraints, depending on cost, etc. For example, information communicated between an end user device and a server may be communicated via the local infrastructure provider network (e.g., skipping the fixed hotspot access network).

Similarly, in the seventh example mode 560 (e.g., the no backbone and mobile hotspots available mode), information (or data) may be communicated between an environment device and a server via the fixed hotspot access network and/or the local infrastructure provider network. Also for example, an environment device may communicate with or through an end-user device (e.g., instead of or in addition to the mobile hotspot access network). As will be seen in the various example modes presented herein, such communication may flexibly occur between an environment device and a server (e.g., communicatively coupled to the local infrastructure provider network) via any of a variety of different communication pathways, for example depending on the availability of a network, depending on bandwidth utilization goals, depending on communication priority, depending on communication time (or latency) and/or reliability constraints, depending on cost, etc. For example, information communicated between an environment device and a server may be communicated via the local infrastructure provider network (e.g., skipping the fixed hotspot access network).

The seventh example mode 560 may be utilized for any of a variety of reasons, non-limiting examples of which are provided herein. In an example controlled space implementation, Cloud access might not be provided (e.g., for security reasons, privacy reasons, etc.), and full (or sufficient) coverage of the coverage area is provided by the fixed hotspot access network, and thus the mobile hotspot access network is not needed. For example, the end-user devices and environment devices may communicate directly (e.g., via Ethernet, Wi-Fi, etc.) with the Fixed APs

Note also that the seventh example mode 560 may be utilized in a scenario in which the backbone provider network and/or fixed hotspot access network are normally available but are currently unavailable (e.g., due to equipment failure, due to communication link failure, due to power outage, due to a temporary denial of service, etc.).

The eighth example mode (or configuration) 570 (e.g., the no backbone, fixed hotspots, and local infrastructure available mode) may, for example, share any or all characteristics with the first example mode 500, albeit without the backbone provider network, local infrastructure provider network, fixed hotspot access network, and communication links therewith. For example, the communication system in the eighth example mode 570 comprises a mobile hotspot access network, end-user devices, and environment devices.

As shown in FIG. 5C, and in FIG. 1 in more detail, the mobile hotspot access network is shown in the eighth example mode 570 to be communicatively coupled to the end-user devices and/or environment devices via one or more wireless links. Many examples of such wireless coupling are provided herein. Further, the end-user devices are also shown in the eighth example mode 570 to be communicatively coupled to the environment devices via one or more wireless links. Many examples of such wireless coupling are provided herein.

In the eighth example mode 570 (e.g., the no backbone, fixed hotspots, and local infrastructure available mode), information (or data) might not (at least currently) be communicated between an end-user device and a server (e.g., a coupled to the backbone provider network, local infrastructure provider network, etc.). Similarly, information (or data) might not (at least currently) be communicated between an environment device and a server (e.g., a coupled to the backbone provider network, local infrastructure provider network, etc.). Note that the environment device may communicate with or through an end-user device (e.g., instead of or in addition to the mobile hotspot access network).

The eighth example mode 570 may be utilized for any of a variety of reasons, non-limiting examples of which are provided herein. In an example implementation, the eighth example mode 570 may be utilized for gathering and/or serving data (e.g., in a delay-tolerant networking scenario), providing peer-to-peer communication through the mobile hotspot access network (e.g., between clients of a single Mobile AP, between clients of respective different Mobile APs, etc.), etc. In another example scenario, the eighth example mode 570 may be utilized in a scenario in which vehicle-to-vehicle communications are prioritized above vehicle-to-infrastructure communications. In yet another example scenario, the eighth example mode 570 may be utilized in a scenario in which all infrastructure access is lost (e.g., in tunnels, parking garages, etc.).

Note also that the eighth example mode 570 may be utilized in a scenario in which the backbone provider network, local infrastructure provider network, and/or fixed hotspot access network are normally available but are currently unavailable (e.g., due to equipment failure, due to communication link failure, due to power outage, due to a temporary denial of service, etc.).

As shown and discussed herein, it is beneficial to have a generic platform that allows multi-mode communications of multiple users or machines within different environments, using multiple devices with multiple technologies, connected to multiple moving/static things with multiple technologies, forming wireless (mesh) hotspot networks over different environments, connected to multiple wired/wireless infrastructure/network backbone providers, ultimately connected to the Internet, Cloud or private network infrastructure.

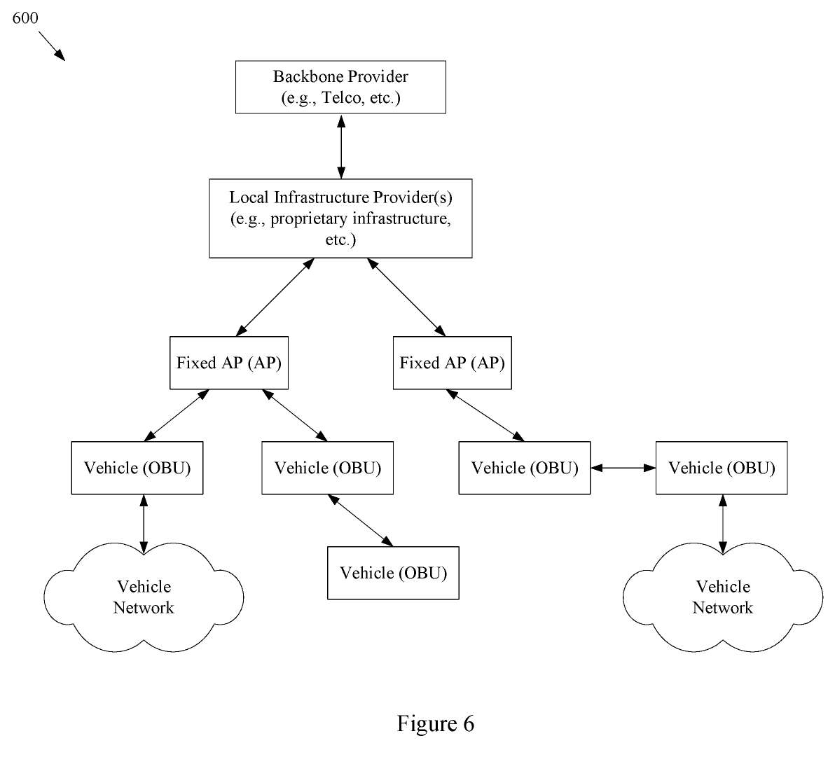

FIG. 6 shows yet another block diagram of an example network configuration, in accordance with various aspects of the present disclosure. The example network 600 may, for example, share any or all characteristics with the other example networks and/or network components 100, 200, 300, 400, and 500-570, discussed herein. Notably, the example network 600 shows a plurality of Mobile APs (or OBUs), each communicatively coupled to a Fixed AP (or RSU), where each Mobile AP may provide network access to a vehicle network (e.g., comprising other vehicles or vehicle networks, user devices, sensor devices, etc.).

In accordance with various aspects of the present disclosure, systems and methods are provided that manage a vehicle communication network, for example in accordance with the location of nodes and end devices, in a way that provides for stable TCP/IP Internet access, among other things. For example, an end user may be provided with a clean and stable Wi-Fi Internet connection that may appear to the end user to be the same as the Wi-Fi Internet connection at the user's home, user's workplace, fixed public Wi-Fi hotspots, etc. For example, for a user utilizing a communication network as described herein, a TCP session may stay active, downloads may process normally, calls may proceed without interruption, etc. As discussed herein, a vehicle communication network in accordance with various aspects of this disclosure may be applied as a transport layer for regular Internet traffic and/or for private network traffic (e.g., extending the access of customer private LANs from the wired network to vehicles and users around them, etc.).

In accordance with an example network implementation, although a user might be always connected to a single Wi-Fi AP of a vehicle, the vehicle (or the access point thereof, for example an OBU) is moving between multiple access points (e.g., Fixed APs, other Mobile APs, cellular base stations, fixed Wi-Fi hotspots, etc.). For example, mobility management implemented in accordance with various aspects of the present disclosure supports the mobility of each vehicle and its users across different communication technologies (e.g., 802.11p, cellular, Wi-Fi, etc.) as the Mobile APs migrate among Fixed APs (and/or Mobile APs) and/or as users migrate between Mobile APs.

In accordance with various aspects of the present disclosure, a mobility controller (MC), which may also be referred to as an LMA or Network Controller, may monitor the location (e.g., network location, etc.) of various nodes (e.g., Mobile APs, etc.) and/or the location of end users connected through them. The mobility controller (MC) may, for example, provide seamless handovers (e.g., maintaining communication session continuity) between different access points and/or different technologies with low link latency and low handover times.

The architecture provided herein is scalable, for example taking advantage of redundant elements and/or functionality to provide load-balancing of control and/or data communication functionality, as well as to decrease failure probability. Various aspects of the present disclosure also provide for decreased control signaling (e.g., in amount and/or frequency), which reduces the control overhead and reduces the size of control tables and tunneling, for example both in backend servers and in APs (e.g., Fixed APs and/or Mobile APs).

Additionally, a communication network (or components thereof) in accordance with various aspects of this disclosure may comprise the ability to interact with mobile devices in order to control some or all of their connection choices and/or to leverage their control functionality. For example, in an example implementation, a mobile application can run in the background, managing the available networks and/or nodes thereof and selecting the one that best fits, and then triggering a handoff to the selected network (or node thereof) before breakdown of the current connection.

The communication network (or components thereof) is also configurable, according to the infrastructure requirements and/or mobility needs of each client, etc. For example, the communication network (or components thereof) may comprise the capability to support different Layer 2 (L2) or Layer 3 (L3) implementations, or combinations thereof, as well as IPv4/IPv6 traffic.

In many instances, the level of congestion on radio frequency (RF) channels in wireless networks results in many collisions between transmissions, resulting in long periods spent waiting for packet transmit opportunities. As a result, the quality-of-service (QoS) experienced by users decreases. In certain situations, such as a crowded part of a city in which a network of moving things is deployed, the RF channel congestion may reach unacceptable levels, causing all services to be delayed or, at worst, completely stop functioning (e.g., “crash”). Various aspects of the present disclosure provide for network nodes in range of one another to balance the load across the available RF channels, and to improve the RF channel conditions, and consequently, the QoS.

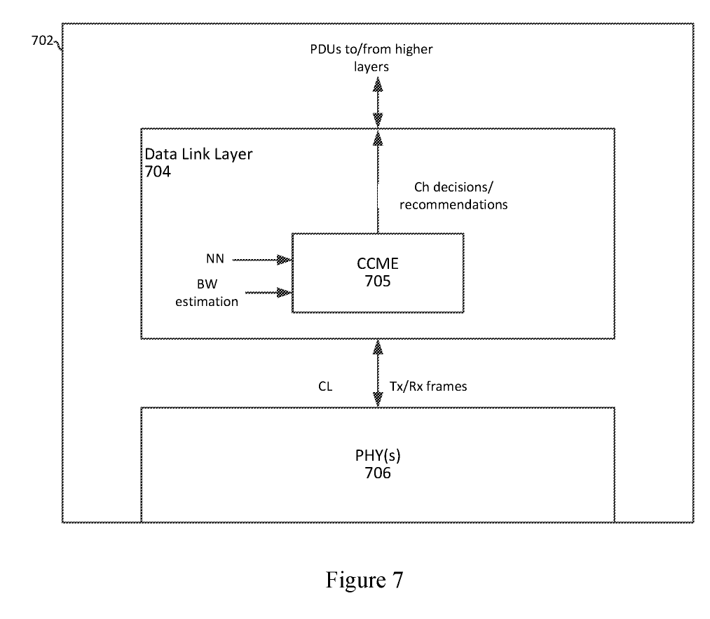

FIG. 7 is an illustration showing an example network node 702 (e.g., a fixed AP or mobile AP) of a network of moving things, in accordance with various aspects of the present disclosure. The network node 702 may, for example, correspond to various network devices of the networks described above with respect to FIGS. 1-7. The example network node 702 of FIG. 7 comprises circuitry, logic, and/or software code implementing one or more physical layer transceivers (PHYs) 706, a data link layer 704, and higher layers of one or more communication protocol stacks. In an example implementation, the network node 702 may comprise multiple PHYs 706 independently supporting more than one service channel (SCH) at the same time. The PHYs 706 of network nodes such as the network node 702 may, for example, be operable to communicate in accordance with a number of different communication protocols including, for example, the IEEE 802.11p standard.

A network node in accordance with various aspects of the present disclosure, such as the example network node 702 of FIG. 7, may comprise circuitry configured to implement a channel coordination management entity (CCME) 705 that may be operable to determine what is referred to herein as Channel Occupancy (CO), and may use the determined CO to coordinate usage of multiple RF channels by the PHY(s) 706. That is, the CO may be used to influence connection decisions with an aim towards improving the QoS experienced on active RF channels of the network. The CCME 705 may determine the CO of various RF channels based on a variety of parameters. For example, in accordance with various aspects of the present disclosure, such parameters may include a parameter representative of channel load (CL); one or more parameters representative of a number of network neighbors (NN); a parameter representative of an estimation of channel capacity or bandwidth (e.g., in bits per second) available for each of one or more links of the network; and/or other parameters that may be generated from analysis of various operating and performance data collected in a network of moving things, such as the example networks shown and discussed with regard to FIGS. 1-7, above.

The CL parameter may, for example, be provided by network node functionality such as the PHY(s) 706, and may be as described in, for example, ETSI TS 102 687 v1.1.1, July 2011, which is hereby incorporated herein by reference. Other methods of computing the CL parameter may also be used including, for example, a level of occupancy based on the channel capacity and consequent available bandwidth.

The NN parameter may be determined by one or more nodes in the network, in which each particular network node occasionally and/or periodically (e.g., regularly in time) sends messages containing information about itself and/or about one or more other network nodes that are within communication range of the particular network node. For example, a particular node device may send information that identifies the particular node device (e.g., a media access control (MAC) address) and similar identifier(s) of each other network node device that the particular node device detects to be within communication range.

The value of the parameter representative of an estimation of channel capacity or bandwidth may be provided by, for example, the Cloud of FIG. 1, which may analyze past and current network connections to generate the estimate values. In accordance with aspects of the present disclosure, the estimate of bandwidth may be generated by a network node such as the network node 702 of FIG. 7 using, for example, time stamps of sent and received frames (e.g., packets), and the result of the estimation may be shared (e.g., broadcast) with other nodes of the network and/or system(s) within the Cloud. Other parameters generated from analysis of data collected in a network of moving things in accordance with the present disclosure may include, for example, historical traffic trends per network node device, historical traffic trends for particular areas within the network, historical rates of packet losses/collisions/etc. per network node device, historical rates of packet losses/collisions/etc. for particular areas within the network, and/or the like.

In an example implementation, the CCME 705 may be operable to output decisions as to the RF channels it has selected and/or RF channels that it recommends for particular services, types of traffic, and/or network neighbors, etc. This RF channel decision/recommendation information may be made available to higher protocol/network layers (e.g., above data link layer 704) so that such higher protocol/network layers may more intelligently select RF channels to use for various services, types of traffic, network neighbors, etc. In this manner, a network of moving things in accordance with various aspects of the present disclosure may reduce the occurrence of situations where a higher protocol/network layer (e.g., application) may select a particular RF channel which is later found to be unacceptable by the CCME 705.

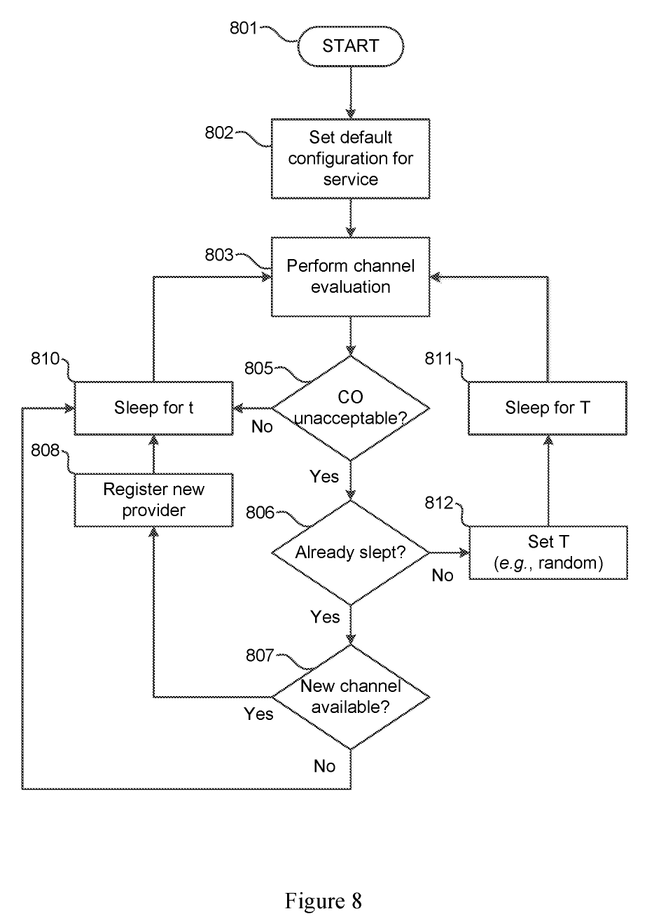

FIG. 8 is a flowchart illustrating an example process for RF channel selection that may be implemented by a CCME of a mobile AP node corresponding to, for example, the CCME 705 of FIG. 7, in a network of moving things in accordance with various aspects of the present disclosure. A CCME of the mobile AP node may perform the process of FIG. 8 for each PHY of the mobile AP node (e.g., PHY(s) 706). The process illustrated by FIG. 8 begins at block 801 and then, at block 802, the PHY is configured to provide a service on a “default” channel, referred to herein as channel ‘n’ for purposes of explanation, in a “default” communication mode. The default channel may be selected by the network node and, for example, may be the channel which has historically been most-heavily used (e.g., in the network as a whole or in the particular current location of the mobile AP). The default communication mode may be selected from, for example, what may be referred to herein as a “continuous channel mode” or a “switching channel mode.” When in “continuous channel mode,” a physical interface (i.e., “PHY”) operates continuously on a particular RF channel for a period of time. When operating in “switching channel mode,” a PHY communicates on different channels during different time slots (e.g., 20 time slots) of a particular period of time (e.g., one second). A PHY in accordance with IEEE 802.11p may be configured to operate on two different RF channels during each time slot (e.g., 50 ms.), which makes it possible for such a PHY to communicate on two channels “at the sme time.” The default communication mode may, for example, be the communication mode which has historically been most-heavily used (e.g., in general or for the particular current location of the mobile AP). In accordance with various aspects of the present disclosure, a first channel may be used as what may be referred to herein as a service channel (SCH), and a second channel may be used as what may be referred to herein as a control channel (CCH). A mobile AP having multiple PHY(s) may, for example, default to an arrangement where a first one of its PHYs is configured to communicate (e.g., listen) on the SCH and a second one of its PHYs is configured to communicate (e.g., listen) on the CCH, although that example does not represent a specific limitation of the present disclosure.

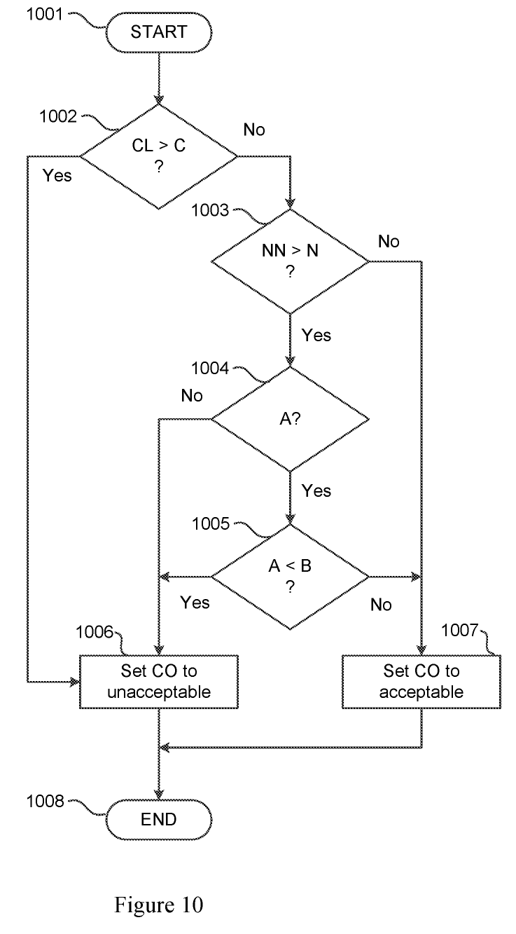

Next, at block 803 of the process of FIG. 8, the CCME (e.g., CCME 705 of FIG. 7) of the mobile AP may perform a channel evaluation sub-process that sets the value of CO (i.e., channel occupancy) to a value that represents either an acceptable level of channel occupancy, or an unacceptable level of channel occupancy. An example channel evaluation process that determines CO in accordance with various aspects of the present disclosure is described below with respect to FIG. 10.

At decision block 805, a determination is made as to whether CO is set to a value that indicates an unacceptable level of channel occupancy. If the level of channel occupancy is indicated to be unacceptable, then the process advances to block 806.

At block 806, a determination is made as to whether the channel selection process has already slept (e.g., waiting without further action for a period of time) after setting CO to unacceptable for the current channel. If, at block 806, it is determined that the channel selection process has already slept after setting CO to indicate an unacceptable channel occupancy for the current channel, then the process of FIG. 8 advances to block 812, where the value of a variable referred to herein as ‘T’ is randomly selected (e.g., values in a range of 0 to 100 ms., which may be based on network measurements), and the process advances to block 811. At block 811, the channel selection process sleeps for ‘T’ time units (e.g., in milliseconds (ms) before returning to block 803.

If, at block 806, it is determined that the process of FIG. 8 has already slept since CO was set to indicate an unacceptable channel occupancy for the current channel, (i.e., the channel occupancy is still unacceptable after the sleep interval), then the process of FIG. 8 advances to block 807.

At block 807, a determination is made as to whether another RF channel is available to the PHY. If it is determined, at block 807, that another RF channel is available, then the PHY is instructed to switch to that channel, which may be referred to herein as channel ‘m’ for purposes of explanation, and the process advances to block 808. At block 808, the mobile AP performing the process registers a new service provider. The term “service provider” used herein may be as described by IEEE std 1609.3, and may be the action of starting a specific channel, or staying on an already configured channel, and advertising to the neighbors of the network node (e.g., mobile AP) that a service is available on the configured channel. Ch advertisements may be sent, for example, over either the CCH or a SCH. As used herein, the action of registering a new “service provider” may be defined as the acknowledgement of the decision made by a CCME, where the chosen channel has passed all CCME criteria and is now being used by the network node. The mobile AP then begins advertising its ability to provide the service on channel ‘m’, and the process advances to block 810. At block 810, the channel selection process sleeps for ‘t’ time units (e.g., in ms.), where ‘t’ may be fixed or randomly set and may be equal to or different than ‘T’. In accordance with aspects of the present disclosure, a CCME may periodically choose/recommend an acceptable RF channel for the network node (e.g., mobile AP) to operate on, based on current conditions. This means that higher layers of the communication protocol may be either triggered by the CCME, or be waiting for a decision by the CCME, so that those higher layers may communicate on the available RF channel. After the “service provider” is registered, all other layers may then be aware that the chosen/recommended RF channel is available for communication, and may then exchange data over the chosen/recommended RF channel. In accordance with various aspects of the present disclosure, the operation of the CCME is an ongoing process, where the CCME continually evaluates the RF channels the network node is operating on, since the conditions of the RF channels of the network are in constant change. In this way, the CCME will either sleep waiting for the next evaluation period, or actually be actively evaluating the RF channels.

If, however, it is determined, at block 807, that no other channel is available to the PHY (e.g., the PHY supports only channel ‘n’), then the process advances to block 810, which is described above.

If, at block 805, it was determined that the CO indicates an acceptable level of channel occupancy, then the process of FIG. 8 advances to block 810, which was described above.

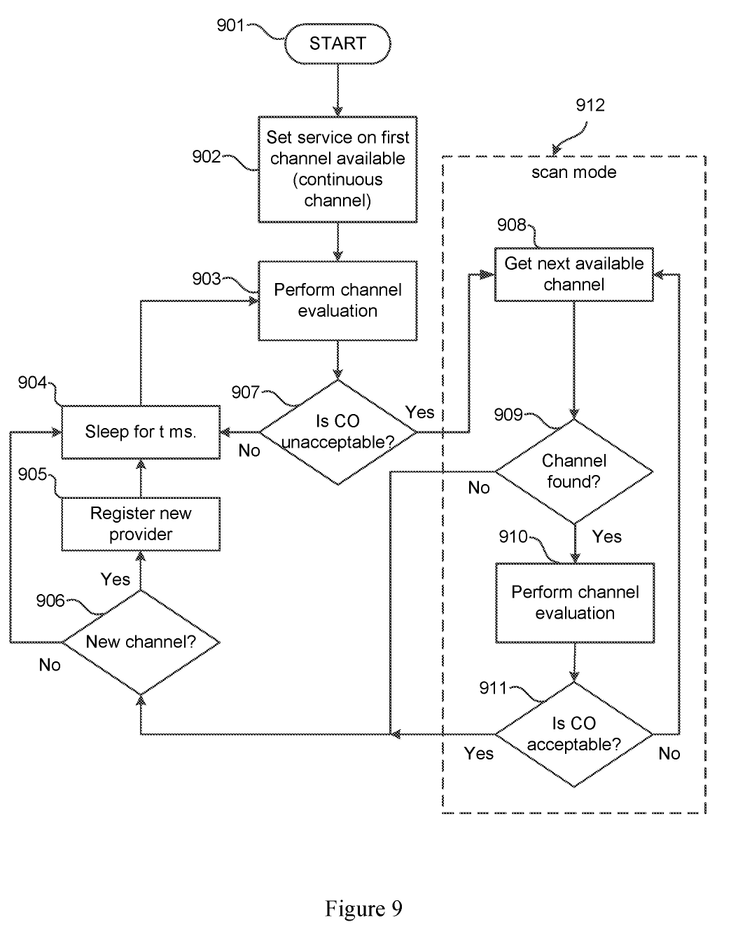

FIG. 9 is a flowchart illustrating an example process for RF channel selection that may be implemented by a CCME of a fixed AP node in a network of moving things in accordance with various aspects of the present disclosure. A CCME of the fixed AP (e.g., any of the fixed AP(s) discussed above in relation to FIGS. 1-6) may perform the process of FIG. 9 for each PHY of the fixed AP. The process illustrated in FIG. 9 begins at block 901 and then, at block 902, the PHY is configured to provide a service on a “default” channel, referred to herein as channel ‘n’ for purposes of explanation, in a “default” communication mode. The default channel may, for example, be the RF channel which has historically been most-heavily used (e.g., in the network as a whole or in the particular location of the fixed AP). The default communication mode may be selected from, for example, what may be referred to herein as a “continuous channel mode” or a “switching channel mode”. The default communication mode may, for example, be the communication mode which has historically been most-heavily used (e.g., in the network in general or in the particular location of the fixed AP). In accordance with various aspects of the present disclosure, a first channel may be used as what may be referred to herein as a service channel (SCH), and a second channel may be used as what may be referred to as a control channel (CCH). A fixed AP having multiple PHY(s) may default to an arrangement where a first one of its PHYs is configured to communicate (e.g., listen) on the SCH and a second one of its PHYs may be configured to communicate (e.g., listen) on the CCH. In accordance with various aspects of the present disclosure, different fixed APs may use their knowledge of network topology to intelligently select default RF channels and/or communication modes such that different fixed APs select different default RF channels and/or communication modes. For example, if two fixed APs are known as being installed close to one another in an area that has a high probability of having communication channel congestion issues, each of the two APs may default to different RF channels and/or different communication modes.

In block 903, the CCME (e.g., CCME 706 of FIG. 7) of the fixed AP may perform a channel evaluation sub-process that sets the value of CO (i.e., channel occupancy) to a value that represents either an acceptable level of channel occupancy, or an unacceptable level of channel occupancy. An example channel evaluation process that determines CO in accordance with various aspects of the present disclosure is described below with respect to FIG. 10.

Next, at block 907, a determination is made as to whether CO is set to indicate an unacceptable level of channel occupancy. If the process of FIG. 9 determines that CO is set to indicate an unacceptable level of channel occupancy, then the CCME enters what is referred to herein as a “scan mode”, and advances to block 908. At block 908, the CCME attempts to acquire (e.g., tune to) a next channel in a list of possible channels (e.g., channel ‘n’+1) on which the PHY is configured to communicate (e.g., receive). After acquiring a next channel, at block 908, the process of FIG. 9 advances to block 909.

At block 909, a determination is made as to whether all possible channels for which the PHY is configured have previously been tried, or if a RF channel has been found that has not already been tried. If the process of FIG. 9 finds, at block 909, that all RF channels have been tried, then the process advances to block 906, which is described below. Otherwise, the process advances to block 910.

At block 910, the CCME (e.g., CCME 706 of FIG. 7) of the fixed AP may perform a channel evaluation sub-process that sets the value of CO (i.e., channel occupancy) to a value that represents either an acceptable level of channel occupancy, or an unacceptable level of channel occupancy, for the channel found at block 909. An example channel evaluation process that determines CO in accordance with various aspects of the present disclosure is described below with respect to FIG. 10. After completion of the channel evaluation sub-process of block 910 and setting the value of CO, the process of FIG. 9 advances to block 911.

At block 911, a determination is made as to whether the value of CO indicates that channel occupancy of the channel found at block 909 is at a level that is acceptable. If, at block 911, it is determined that the value of CO indicates that channel occupancy on the found channel is acceptable, then the process of FIG. 9 advances to block 906. At block 906, a determination is made as to whether a new RF channel was found at block 909. If it is determined, at block 906, that a new channel has been found (i.e., an RF channel that has not already been tried), then the process advances to block 905.

At block 905, the CCME of the fixed AP performing the process of FIG. 9 registers a new service provider (e.g., recorded in an internal table of the IEEE std. 1609.3 “WAVE Management Entity”) and begins advertising the ability of the fixed AP to provide the service on the channel found and selected while in ‘scan mode’ (e.g., begins including the service in “WAVE Service Advertisement (WSA)” frames that are sent to neighbors of the network node). After block 905, the process advances to block 904.

At block 906, if it is determined that a new channel was not found at block 909, then the process of FIG. 9 advances to block 904.

At block 904, the fixed AP sleeps for an amount of time ‘t’ that may, for example, be a fixed amount of time or be randomly assigned, and then the process of FIG. 9 returns to block 903, described above.

At block 907, if the CO of the channel determined at block 902 is acceptable, then the process performed by the CCME of the fixed AP advances to block 904, described above.

FIG. 10 is a flowchart illustrating an example process for performing channel evaluation in accordance with various aspects of the present disclosure. The example channel evaluation process of FIG. 10 may, for example, correspond to the functionality referenced by the “Perform Channel Evaluation” block 803 of FIG. 8, and blocks 903 and 910 of FIG. 9. The process of FIG. 10 begins at block 1001 and then, at block 1002, the value of the CL (i.e., channel load) parameter, discussed above, is compared to a parameter value ‘C’, which is a determined maximum value of the CL parameter. The value of ‘C’ may, for example, be predetermined and/or be determined dynamically based on, for example, past and/or present network conditions and/or activity. For example, “C” may be an initial value provisioned into the network node by the operator of the network and/or a value provided by a remote system/entity in “The Cloud” (e.g., see FIG. 1) using, for example, historical data of a particular geographic location. If CL is greater than ‘C’, then in block 1006, CO may be set to a value representing an unacceptable level of channel occupancy. In accordance with various aspects of the present disclosure, ‘C’ may be interpreted as a “flag” representing an unacceptable (e.g., “0”) or an acceptable (e.g., “1”) channel occupancy condition.

Returning to block 1002, if it is determined that the value of CL is not greater than the value of ‘C’ then, at block 1003, the value of the parameter NN is compared to the value of ‘N’, which may be used herein to represent a determined maximum number of neighbor nodes. The value of ‘N’ may be predetermined and/or determined dynamically based on, for example, past and/or present network conditions and/or activity. In accordance with various aspects of the present disclosure, ‘N’ may, for example, be measured and set as a fixed maximum number of allowed neighbors operating on a certain RF channel, or it may be a network parameter, where ‘N’ may be, for example, a requirement of a network node not having more than ‘N’ neighbors on the same RF channel. If the value of NN is not greater than ‘N’, then the process of FIG. 10 advances to block 1007, and the value of CO is set to indicate that the level of channel occupancy for the current channel is acceptable.

Returning to block 1003, if it is determined the value of NN is greater than ‘N’, then the process advances to block 1004, where it is determined whether a bandwidth estimate, referred to herein as ‘A’, is available. Such a bandwidth estimate may, for example, be available from the Cloud of FIG. 1, or from a local bandwidth estimation circuit. For example, the bandwidth estimate may be an output of a rate adaptation algorithm, such as that described in U.S. Provisional Patent Application Ser. No. 62/250,544, entitled “Adaptive Rate Control for Vehicular Networks,” filed Nov. 4, 2015, the complete subject matter of which is hereby incorporated herein, in its entirety. Such a bandwidth estimate may, for example, be sent to a system/entity located in “The Cloud” for specific geographic locations with the coverage area of the network described herein. In addition, functionality of a system/entity in “The Cloud” may retrieve the historical bandwidth estimate data for specific geographic locations, over time, and may use such data locally, for comparison. If it is determined, at block 1004, that a bandwidth estimate is not available, then the process advances to block 1006. Otherwise, the process of FIG. 10 advances to block 1005.

At block 1005, a determination is made as to whether bandwidth estimate ‘A’ is less than a determined minimum value ‘B’. The value of ‘B’ may, for example, be predetermined and/or determined dynamically based on, for example, past and/or present network conditions and/or activity. If ‘A’ is less than ‘B’, then the process advances to block 1006. Otherwise the process of FIG. 10 advances to block 1007.

At blocks 1006 and 1007, values that indicate that the channel occupancy of the current channel is unacceptable and acceptable are, respectively, assigned to parameter CO.

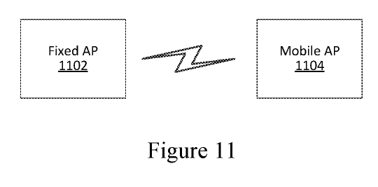

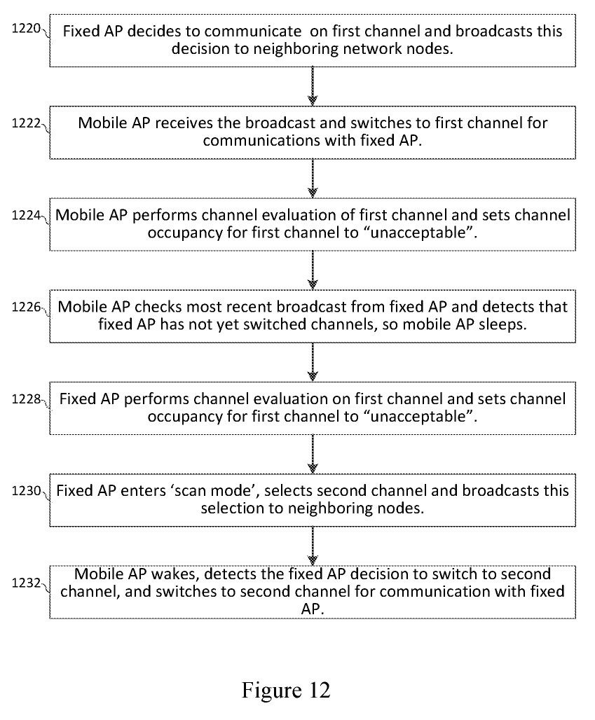

FIG. 11 illustrates a block diagram showing a fixed AP 1102 and a mobile AP 1104 communicating with one another in a manner discussed, below, with respect to FIG. 12, in accordance with various aspects of the present disclosure.

FIG. 12 illustrates an example process in which a fixed AP and a mobile AP such as, for example, the fixed AP 1102 and mobile AP 1104 of FIG. 11, decide upon a channel via which to communicate, in accordance with aspects of this disclosure. The process of FIG. 12 begins at block 1220, where a fixed AP (e.g., the fixed AP 1102) decides to communicate using “Channel 1” in, for example, a continuous channel mode. The fixed AP (e.g., fixed AP 1102) may broadcast (i.e., “advertise”) this decision to neighboring network nodes using, for example, a “control channel” (i.e., “CCH”) or a “service channel” (i.e., “SCH”) using, for example, a format other than an Internet Protocol (IP) frame. In accordance with various aspects of the present disclosure, a “WAVE Short Message Protocol” (i.e., “WSMP”) may be used for such advertisement communication. This act may, for example, correspond to the actions of block 1002 of FIG. 10.

At block 1222, a mobile AP (e.g., the mobile AP 1104) may receive the broadcast from the fixed AP (e.g., fixed AP 1102), and may switch to continuous channel mode on “Channel 1” to enable communication with the fixed AP (i.e., fixed AP 1102). This may, for example, correspond to blocks 907 and 908 of FIG. 9.

Next, at block 1224, the mobile AP (e.g., mobile AP 1104) may perform a process of valuation of “Channel 1” and may set CO to indicate an unacceptable level of channel occupancy. This may, for example, correspond to block 903 of FIG. 9.

At block 1226, the mobile AP (e.g., mobile AP 1104) may check the most recent information broadcast by the fixed AP (e.g., fixed AP 1102), which may indicate that the fixed AP (e.g., fixed AP 1102) has not yet switched away from “Channel 1”. Accordingly, the CCME of the mobile AP (e.g., a CCME such as CCME 705 of the network node 702 of FIG. 7 (e.g., mobile AP 1104)) may sleep for time ‘t’. These actions may, for example, correspond to blocks 907 and 910 of FIG. 9.

Then, at block 1228, the fixed AP (e.g., fixed AP 1102) may perform a channel evaluation of “Channel 1” and may set parameter CO to indicate that channel occupancy is unacceptable. This may, for example, correspond to block 1003 of FIG. 10.

At block 1230, the fixed AP (e.g., fixed AP 1102) may enter ‘scan mode’, and may select “Channel 3” as the channel to use instead of “Channel 1”, and may broadcast this decision to neighboring network nodes. This may, for example, correspond to the actions of blocks 1008-1011, 1006, and 1005 of FIG. 10.

Finally, at block 1232, the mobile AP (e.g., mobile AP 1104) may wake from the sleep, and may check the latest information broadcast by the fixed AP (e.g., fixed AP 1102) to discover that the fixed AP (e.g., fixed AP 1102) has switched to “Channel 3”. The mobile AP (e.g., mobile AP 1104) may then switch its own channel usage to “Channel 3” for communications with the fixed AP (e.g., fixed AP 1102). This may, for example, correspond to blocks 902, 905, 906, and 907 of FIG. 9.

It should be noted that although the above examples describe communication between two network nodes that include a fixed AP and a mobile AP, the two nodes may be other network elements that participate in communication over RF channels such as, for example, any first and second network elements of those shown and discussed with regard to FIGS. 1-12, above, that are suitably equipped.

In accordance with various aspects of the present disclosure, the CCME (e.g., CCME 705 of FIG. 7) of mobile and/or fixed APs may perform processes similar to those described above for controlling or adapting data rate in addition to, or instead of, channel selection. Additional information about adaptive rate control may be found, for example, in U.S. Provisional Patent Application Ser. No. 62/250,544, entitled “Adaptive Rate Control for Vehicular Networks,” filed Nov. 4, 2015, which is hereby incorporated herein, in its entirety.

Channel selection processes in accordance with various aspects of the present disclosure, such as the examples illustrated in FIGS. 8-10 may be used in combination with other processes for selecting channels. For example, for areas where sufficiently reliable historical data is available, the Cloud and/or other nodes of a network of moving things may be operable to analyze such data to determine which RF channel is best to use for particular links, particular communications traffic, particular network devices, particular geographic areas of the network, etc. This may reduce the frequency with which one or more of the processes of FIGS. 8-10 need to be performed, thus avoiding down time during channel scanning/sensing/etc. and reducing the amount of bandwidth used for control traffic.

Various aspects of this disclosure provide for channel coordination in a network of moving things. As a non-limiting example, various aspects of this disclosure provide communication network architectures, systems, and methods for supporting a communication network comprising a complex array of both static and moving communication nodes (e.g., the Internet of moving things). While the foregoing has been described with reference to certain aspects and examples, it will be understood by those skilled in the art that various changes may be made and equivalents may be substituted without departing from the scope of the disclosure. In addition, many modifications may be made to adapt a particular situation or material to the teachings of the disclosure without departing from its scope. Therefore, it is intended that the disclosure not be limited to the particular example(s) disclosed, but that the disclosure will include all examples falling within the scope of the appended claims.

Aspects of the present disclosure may be seen in a method of coordinating radio frequency channel use by nodes in a network comprising a plurality of nodes. Such a method may comprise configuring an operating channel of a first node of the plurality of nodes to a first radio frequency channel; evaluating, by the first node, one or more conditions of the first radio frequency channel; and determining, by the first node, whether the one or more conditions of the operating channel are acceptable for use in communicating with a second node of the plurality of nodes. The method may further comprise waiting, by the first node, without further action for a first period of time, if the one or more conditions of the operating channel are acceptable for use in communicating with the second node; and waiting, by the first node, without further action for a second period of time, if the one or more conditions of the operating channel are not acceptable for use in communicating with the second node and the first node has not previously waited for the operating channel. The method may also comprise determining, by the first node, whether an other radio frequency channel is available for use by the first node, if the one or more conditions of the operating channel are not acceptable for use in communicating with the second node and the first node has previously waited for the operating channel; setting, by the first node, the operating channel of the first node to the other radio frequency channel; and determining, by the first node, whether the one or more conditions of the operating channel are acceptable for use in communicating with the second node.

In accordance with some aspects of the present disclosure, the one or more conditions may comprise an indication of channel occupancy, an indication of channel load, and/or a data transmission rate. The second period of time may be randomly chosen. The method may also comprise broadcasting the operating channel, by the first node, to neighboring network nodes. The broadcasting may be performed by the first node using a radio frequency channel different from the operating channel. The first channel may be selected by the first node from a plurality of radio frequency channels, and one or both of the first node and the second node may comprise two or more physical layer interfaces (PHY) independently capable of communication on a same plurality of radio frequency channels.

Additional aspects of the present disclosure may be found in a system for coordinating radio frequency channel use by nodes in a network comprising a plurality of nodes. Such a system may comprise at least one processor operable in a first node of the plurality of nodes. The at least one processor may be operable to, at least, configure an operating channel of the first node of the plurality of nodes to a first radio frequency channel; evaluate one or more conditions of the first radio frequency channel; and determine whether the one or more conditions of the operating channel are acceptable for use in communicating with a second node of the plurality of nodes. The at least one processor may also be operable to wait, without further action for a first period of time, if the one or more conditions of the operating channel are acceptable for use in communicating with the second node; and wait without further action for a second period of time, if the one or more conditions of the operating channel are not acceptable for use in communicating with the second node and the first node has not previously waited for the operating channel. The at least one processor may be further operable to determine whether an other radio frequency channel is available for use by the first node, if the one or more conditions of the operating channel are not acceptable for use in communicating with the second node and the first node has previously waited for the operating channel; set the operating channel of the first node to the other radio frequency channel; and determine whether the one or more conditions of the operating channel are acceptable for use in communicating with the second node.

In accordance with various aspects of the present disclosure, the one or more conditions may comprise an indication of channel occupancy, an indication of channel load, and/or a data transmission rate. The second period of time may be randomly chosen. The at least one processor may be further operable to broadcast the operating channel, by the first node, to neighboring network nodes. The broadcasting may be performed by the first node using a radio frequency channel different from the operating channel. The first channel may be selected by the first node from a plurality of radio frequency channels, and one or both of the first node and the second node may comprise two or more physical layer interfaces (PHY) independently capable of communication on a same plurality of radio frequency channels.

Yet additional aspects of the present disclosure may be found in a non-transitory computer-readable medium having a plurality of code sections, where each code section comprises a plurality of instructions executable by at least one processor. The executable instructions may cause the at least one processor to perform the steps of a method of coordinating radio frequency channel use by nodes in a network comprising a plurality of nodes, where the steps of the method are as described above.

In accordance with various aspects of this disclosure, examples of the networks and/or components thereof presented herein are provided in U.S. Provisional Application Ser. No. 62/222,192, titled “Communication Network of Moving Things,” filed on Sep. 22, 2015, which is hereby incorporated herein by reference in its entirety.

In accordance with various aspects of this disclosure, the networks and/or components thereof presented herein are provided with systems and methods for integrating such networks and/or components with other networks and systems, non-limiting examples of which are provided in U.S. Provisional Application Ser. No. 62/221,997, titled “Integrated Communication Network for A Network of Moving Things,” filed on Sep. 22, 2015, which is hereby incorporated herein by reference in its entirety.

Also, in accordance with various aspects of this disclosure, the networks and/or components thereof presented herein are provided with systems and methods for synchronizing such networks and/or components, non-limiting examples of which are provided in U.S. Provisional Application Ser. No. 62/222,016, titled “Systems and Methods for Synchronizing a Network of Moving Things,” filed on Sep. 22, 2015, which is hereby incorporated herein by reference in its entirety.

Additionally, in accordance with various aspects of this disclosure, the networks and/or components thereof presented herein are provided with systems and methods for managing such networks and/or components, non-limiting examples of which are provided in U.S. Provisional Application Ser. No. 62/222,042, titled “Systems and Methods for Managing a Network of Moving Things,” filed on Sep. 22, 2015, which is hereby incorporated herein by reference in its entirety.

Further, in accordance with various aspects of this disclosure, the networks and/or components thereof presented herein are provided with systems and methods for monitoring such networks and/or components, non-limiting examples of which are provided in U.S. Provisional Application Ser. No. 62/222,066, titled “Systems and Methods for Monitoring a Network of Moving Things,” filed on Sep. 22, 2015, which is hereby incorporated herein by reference in its entirety.

Still further, in accordance with various aspects of this disclosure, the networks and/or components thereof presented herein are provided with systems and methods for detecting and/or classifying anomalies in such networks and/or components, non-limiting examples of which are provided in U.S. Provisional Application Ser. No. 62/222,077, titled “Systems and Methods for Detecting and Classifying Anomalies in a Network of Moving Things,” filed on Sep. 22, 2015, which is hereby incorporated herein by reference in its entirety.

Yet further, in accordance with various aspects of this disclosure, the networks and/or components thereof presented herein are provided with systems and methods for managing mobility in such networks and/or components, non-limiting examples of which are provided in U.S. Provisional Application Ser. No. 62/222,098, titled “Systems and Methods for Managing Mobility in a Network of Moving Things,” filed on Sep. 22, 2015, which is hereby incorporated herein by reference in its entirety.

Also, in accordance with various aspects of this disclosure, the networks and/or components thereof presented herein are provided with systems and methods for managing connectivity in such networks and/or components, non-limiting examples of which are provided in U.S. Provisional Application Ser. No. 62/222,121, titled “Systems and Methods for Managing Connectivity a Network of Moving Things,” filed on Sep. 22, 2015, which is hereby incorporated herein by reference in its entirety.

Additionally, in accordance with various aspects of this disclosure, the networks and/or components thereof presented herein are provided with systems and methods for collecting sensor data in such networks and/or components, non-limiting examples of which are provided in U.S. Provisional Application Ser. No. 62/222,135, titled “Systems and Methods for Collecting Sensor Data in a Network of Moving Things,” filed on Sep. 22, 2015, which is hereby incorporated herein by reference in its entirety.

Further, in accordance with various aspects of this disclosure, the networks and/or components thereof presented herein are provided with systems and methods for interfacing with such networks and/or components, non-limiting examples of which are provided in U.S. Provisional Application Ser. No. 62/222,145, titled “Systems and Methods for Interfacing with a Network of Moving Things,” filed on Sep. 22, 2015, which is hereby incorporated herein by reference in its entirety.

Still further, in accordance with various aspects of this disclosure, the networks and/or components thereof presented herein are provided with systems and methods for interfacing with a user of such networks and/or components, non-limiting examples of which are provided in U.S. Provisional Application Ser. No. 62/222,150, titled “Systems and Methods for Interfacing with a User of a Network of Moving Things,” filed on Sep. 22, 2015, which is hereby incorporated herein by reference in its entirety.

Yet further, in accordance with various aspects of this disclosure, the networks and/or components thereof presented herein are provided with systems and methods for data storage and processing in such networks and/or components, non-limiting examples of which are provided in U.S. Provisional Application Ser. No. 62/222,168, titled “Systems and Methods for Data Storage and Processing for a Network of Moving Things,” filed on Sep. 22, 2015, which is hereby incorporated herein by reference in its entirety.

Also, in accordance with various aspects of this disclosure, the networks and/or components thereof presented herein are provided with systems and methods for vehicle traffic management in such networks and/or components, non-limiting examples of which are provided in U.S. Provisional Application Ser. No. 62/222,183, titled “Systems and Methods for Vehicle Traffic Management in a Network of Moving Things,” filed on Sep. 22, 2015, which is hereby incorporated herein by reference in its entirety.

Additionally, in accordance with various aspects of this disclosure, the networks and/or components thereof presented herein are provided with systems and methods for environmental management in such networks and/or components, non-limiting examples of which are provided in U.S. Provisional Application Ser. No. 62/222,186, titled “Systems and Methods for Environmental Management in a Network of Moving Things,” filed on Sep. 22, 2015, which is hereby incorporated herein by reference in its entirety.

Further, in accordance with various aspects of this disclosure, the networks and/or components thereof presented herein are provided with systems and methods for managing port or shipping operation in such networks and/or components, non-limiting examples of which are provided in U.S. Provisional Application Ser. No. 62/222,190, titled “Systems and Methods for Port Management in a Network of Moving Things,” filed on Sep. 22, 2015, which is hereby incorporated herein by reference in its entirety.

Also, in accordance with various aspects of this disclosure, the networks and/or components thereof presented herein are provided with systems and methods for enhancing the accuracy of positioning or location information based at least in part on historical data, non-limiting examples of which are provided in U.S. Provisional Application Ser. No. 62/244,828, titled “Utilizing Historical Data to Correct GPS Data in a Network of Moving Things,” filed on Oct. 22, 2015, which is hereby incorporated herein by reference in its entirety.

Additionally, in accordance with various aspects of this disclosure, the networks and/or components thereof presented herein are provided with systems and methods for enhancing the accuracy of position or location of positioning or location information based at least in part on the utilization of anchors, non-limiting examples of which are provided in U.S. Provisional Application Ser. No. 62/244,930, titled “Using Anchors to Correct GPS Data in a Network of Moving Things,” filed on Oct. 22, 2015, which is hereby incorporated herein by reference in its entirety.

Further, in accordance with various aspects of this disclosure, the networks and/or components thereof presented herein are provided with systems and methods for providing communication between applications, non-limiting examples of which are provided in U.S. Provisional Application Ser. No. 62/246,368, titled “Systems and Methods for Inter-Application Communication in a Network of Moving Things,” filed on Oct. 26, 2015, which is hereby incorporated herein by reference in its entirety.

Still further, in accordance with various aspects of this disclosure, the networks and/or components thereof presented herein are provided with systems and methods for probing, analyzing and/or validating communication, non-limiting examples of which are provided in U.S. Provisional Application Ser. No. 62/246,372, titled “Systems and Methods for Probing and Validating Communication in a Network of Moving Things,” filed on Oct. 26, 2015, which is hereby incorporated herein by reference in its entirety.

Yet further, in accordance with various aspects of this disclosure, the networks and/or components thereof presented herein are provided with systems and methods for adapting communication rate, non-limiting examples of which are provided in U.S. Provisional Application Ser. No. 62/250,544, titled “Adaptive Rate Control for Vehicular Networks,” filed on Nov. 4, 2015, which is hereby incorporated herein by reference in its entirety.

Also, in accordance with various aspects of this disclosure, the networks and/or components thereof presented herein are provided with systems and methods for reconfiguring and adapting hardware, non-limiting examples of which are provided in U.S. Provisional Application Ser. No. 62/273,878, titled “Systems and Methods for Reconfiguring and Adapting Hardware in a Network of Moving Things,” filed on Dec. 31, 2015, which is hereby incorporated herein by reference in its entirety.

Additionally, in accordance with various aspects of this disclosure, the networks and/or components thereof presented herein are provided with systems and methods for optimizing the gathering of data, non-limiting examples of which are provided in U.S. Provisional Application Ser. No. 62/253,249, titled “Systems and Methods for Optimizing Data Gathering in a Network of Moving Things,” filed on Nov. 10, 2015, which is hereby incorporated herein by reference in its entirety.

Further, in accordance with various aspects of this disclosure, the networks and/or components thereof presented herein are provided with systems and methods for performing delay tolerant networking, non-limiting examples of which are provided in U.S. Provisional Application Ser. No. 62/257,421, titled “Systems and Methods for Delay Tolerant Networking in a Network of Moving Things,” filed on Nov. 19, 2015, which is hereby incorporated herein by reference in its entirety.

Still further, in accordance with various aspects of this disclosure, the networks and/or components thereof presented herein are provided with systems and methods for improving the coverage and throughput of mobile access points, non-limiting examples of which are provided in U.S. Provisional Application Ser. No. 62/265,267, titled “Systems and Methods for Improving Coverage and Throughput of Mobile Access Points in a Network of Moving Things,” filed on Dec. 9, 2015, which is hereby incorporated herein by reference in its entirety.

Yet further, in accordance with various aspects of this disclosure, the networks and/or components thereof presented herein are provided with systems and methods for coordinating channel utilization, non-limiting examples of which are provided in U.S. Provisional Application Ser. No. 62/270,858, titled “Channel Coordination in a Network of Moving Things,” filed on Dec. 22, 2015, which is hereby incorporated herein by reference in its entirety.

Also, in accordance with various aspects of this disclosure, the networks and/or components thereof presented herein are provided with systems and methods for implementing a network coded mesh network in the network of moving things, non-limiting examples of which are provided in U.S. Provisional Application Ser. No. 62/257,854, titled “Systems and Methods for Network Coded Mesh Networking in a Network of Moving Things,” filed on Nov. 20, 2015, which is hereby incorporated herein by reference in its entirety.

Additionally, in accordance with various aspects of this disclosure, the networks and/or components thereof presented herein are provided with systems and methods for improving the coverage of fixed access points, non-limiting examples of which are provided in U.S. Provisional Application Ser. No. 62/260,749, titled “Systems and Methods for Improving Fixed Access Point Coverage in a Network of Moving Things,” filed on Nov. 30, 2015, which is hereby incorporated herein by reference in its entirety.

Further, in accordance with various aspects of this disclosure, the networks and/or components thereof presented herein are provided with systems and methods for managing mobility controllers and their network interactions, non-limiting examples of which are provided in U.S. Provisional Application Ser. No. 62/273,715, titled “Systems and Methods for Managing Mobility Controllers and Their Network Interactions in a Network of Moving Things,” filed on Dec. 31, 2015, which is hereby incorporated herein by reference in its entirety.

Still further, in accordance with various aspects of this disclosure, the networks and/or components thereof presented herein are provided with systems and methods for managing and/or triggering handovers of mobile access points, non-limiting examples of which are provided in U.S. Provisional Application Ser. No. 62/281,432, titled “Systems and Methods for Managing and Triggering Handovers of Mobile Access Points in a Network of Moving Things,” filed on Jan. 21, 2016, which is hereby incorporated herein by reference in its entirety.

Yet further, in accordance with various aspects of this disclosure, the networks and/or components thereof presented herein are provided with systems and methods for performing captive portal-related control and management, non-limiting examples of which are provided in U.S. Provisional Application Ser. No. 62/268,188, titled “Captive Portal-related Control and Management in a Network of Moving Things,” filed on Dec. 16, 2015, which is hereby incorporated herein by reference in its entirety.

Also, in accordance with various aspects of this disclosure, the networks and/or components thereof presented herein are provided with systems and methods for extrapolating high-value data, non-limiting examples of which are provided in U.S. Provisional Application Ser. No. 62/270,678, titled “Systems and Methods to Extrapolate High-Value Data from a Network of Moving Things,” filed on Dec. 22, 2015, which is hereby incorporated herein by reference in its entirety.

Additionally, in accordance with various aspects of this disclosure, the networks and/or components thereof presented herein are provided with systems and methods for providing remote software updating and distribution, non-limiting examples of which are provided in U.S. Provisional Application Ser. No. 62/272,750, titled “Systems and Methods for Remote Software Update and Distribution in a Network of Moving Things,” filed on Dec. 30, 2015, which is hereby incorporated herein by reference in its entirety.

Further, in accordance with various aspects of this disclosure, the networks and/or components thereof presented herein are provided with systems and methods for providing remote configuration updating and distribution, non-limiting examples of which are provided in U.S. Provisional Application Ser. No. 62/278,662, titled “Systems and Methods for Remote Configuration Update and Distribution in a Network of Moving Things,” filed on Jan. 14, 2016, which is hereby incorporated herein by reference in its entirety.

Still further, in accordance with various aspects of this disclosure, the networks and/or components thereof presented herein are provided with systems and methods for adapting the network, for example automatically, based on user feedback, non-limiting examples of which are provided in U.S. Provisional Application Ser. No. 62/286,243, titled “Systems and Methods for Adapting a Network of Moving Things Based on User Feedback,” filed on Jan. 22, 2016, which is hereby incorporated herein by reference in its entirety.

Yet further, in accordance with various aspects of this disclosure, the networks and/or components thereof presented herein are provided with systems and methods for enhancing and/or guaranteeing data integrity when building or performing data analytics, non-limiting examples of which are provided in U.S. Provisional Application Ser. No. 62/278,764, titled “Systems and Methods to Guarantee Data Integrity When Building Data Analytics in a Network of Moving Things,” Jan. 14, 2016, which is hereby incorporated herein by reference in its entirety.

Also, in accordance with various aspects of this disclosure, the networks and/or components thereof presented herein are provided with systems and methods for performing self-initialization and/or automated bootstrapping of mobile access points, non-limiting examples of which are provided in U.S. Provisional Application Ser. No. 62/286,515, titled “Systems and Methods for Self-Initialization and Automated Bootstrapping of Mobile Access Points in a Network of Moving Things,” filed on Jan. 25, 2016, which is hereby incorporated herein by reference in its entirety.

Additionally, in accordance with various aspects of this disclosure, the networks and/or components thereof presented herein are provided with systems and methods for managing power supply and/or utilization, non-limiting examples of which are provided in U.S. Provisional Application Ser. No. 62/295,602, titled “Systems and Methods for Power Management in a Network of Moving Things,” filed on Feb. 16, 2016, which is hereby incorporated herein by reference in its entirety.

Further, in accordance with various aspects of this disclosure, the networks and/or components thereof presented herein are provided with systems and methods for automating and easing the installation and setup of the infrastructure, non-limiting examples of which are provided in U.S. Provisional Application Ser. No. 62/299,269, titled “Systems and Methods for Automating and Easing the Installation and Setup of the Infrastructure Supporting a Network of Moving Things,” filed on Feb. 24, 2016, which is hereby incorporated herein by reference in its entirety.

In summary, various aspects of this disclosure provide communication network architectures, systems and methods for supporting a network of mobile nodes, for example comprising a combination of mobile and stationary nodes. As a non-limiting example, various aspects of this disclosure provide communication network architectures, systems, and methods for supporting a dynamically configurable communication network comprising a complex array of both static and moving communication nodes (e.g., the Internet of moving things). While the foregoing has been described with reference to certain aspects and examples, it will be understood by those skilled in the art that various changes may be made and equivalents may be substituted without departing from the scope of the disclosure. In addition, many modifications may be made to adapt a particular situation or material to the teachings of the disclosure without departing from its scope. Therefore, it is intended that the disclosure not be limited to the particular example(s) disclosed, but that the disclosure will include all examples falling within the scope of the appended claims.

What is claimed is:

1. A method of coordinating radio frequency channel use by nodes in a network comprising a plurality of nodes, the method comprising:
configuring an operating channel of a first node of the plurality of nodes to a first radio frequency channel;
evaluating, by the first node, one or more conditions of the first radio frequency channel;
determining, by the first node, whether the one or more conditions of the operating channel are acceptable for use in communicating with a second node of the plurality of nodes;
waiting, by the first node, without further action for a first period of time, if the one or more conditions of the operating channel are acceptable for use in communicating with the second node;
waiting, by the first node, without further action for a second period of time, if the one or more conditions of the operating channel are not acceptable for use in communicating with the second node and the first node has not previously waited for the operating channel;
determining, by the first node, whether an other radio frequency channel is available for use by the first node, if the one or more conditions of the operating channel are not acceptable for use in communicating with the second node and the first node has previously waited for the operating channel;
setting, by the first node, the operating channel of the first node to the other radio frequency channel; and
determining, by the first node, whether the one or more conditions of the operating channel are acceptable for use in communicating with the second node.

2. The method according to claim 1, wherein the one or more conditions comprise an indication of channel occupancy.

3. The method according to claim 1, wherein the one or more conditions comprise an indication of channel load.

4. The method according to claim 1, wherein the one or more conditions comprise a data transmission rate.

5. The method according to claim 1, wherein the second period of time is randomly chosen.

6. The method according to claim 1, further comprising:
broadcasting the operating channel, by the first node, to neighboring network nodes.

7. The method according to claim 6, wherein the broadcasting is performed by the first node using a radio frequency channel different from the operating channel.

8. The method according to claim 1, wherein the first channel is selected by the first node from a plurality of radio frequency channels.

9. The method according to claim 1, wherein one or both of the first node and the second node comprise two or more physical layer interfaces (PHY) independently capable of communication on a same plurality of radio frequency channels.

10. A system for coordinating radio frequency channel use by nodes in a network comprising a plurality of nodes, the system comprising:
at least one processor operable in a first node of the plurality of nodes to, at least:
configure an operating channel of the first node of the plurality of nodes to a first radio frequency channel;
evaluate one or more conditions of the first radio frequency channel;
determine whether the one or more conditions of the operating channel are acceptable for use in communicating with a second node of the plurality of nodes;
wait, without further action for a first period of time, if the one or more conditions of the operating channel are acceptable for use in communicating with the second node;
wait without further action for a second period of time, if the one or more conditions of the operating channel are not acceptable for use in communicating with the second node and the first node has not previously waited for the operating channel;
determine whether an other radio frequency channel is available for use by the first node, if the one or more conditions of the operating channel are not acceptable for use in communicating with the second node and the first node has previously waited for the operating channel;
set the operating channel of the first node to the other radio frequency channel; and
determine whether the one or more conditions of the operating channel are acceptable for use in communicating with the second node.

11. The system according to claim 10, wherein the one or more conditions comprise an indication of channel occupancy.

12. The system according to claim 10, wherein the one or more conditions comprise an indication of channel load.

13. The system according to claim 10, wherein the one or more conditions comprise a data transmission rate.

14. The system according to claim 10, wherein the second period of time is randomly chosen.

15. The system according to claim 10, further comprising:
broadcast the operating channel, by the first node, to neighboring network nodes.

16. The system according to claim 15, wherein the broadcasting is performed by the first node using a radio frequency channel different from the operating channel.

17. The system according to claim 10, wherein the first channel is selected by the first node from a plurality of radio frequency channels.

18. The system according to claim 10, wherein one or both of the first node and the second node comprise two or more physical layer interfaces (PHY) independently capable of communication on a same plurality of radio frequency channels.

19. A non-transitory computer-readable medium having a plurality of code sections, each code section comprising a plurality of instructions executable by at least one processor, the executable instructions causing the at least one processor to perform the steps of a method of coordinating radio frequency channel use by nodes in a network comprising a plurality of nodes, the steps of the method comprising:
configuring an operating channel of a first node of the plurality of nodes to a first radio frequency channel;
evaluating, by the first node, one or more conditions of the first radio frequency channel;
determining, by the first node, whether the one or more conditions of the operating channel are acceptable for use in communicating with a second node of the plurality of nodes;
waiting, by the first node, without further action for a first period of time, if the one or more conditions of the operating channel are acceptable for use in communicating with the second node;
waiting, by the first node, without further action for a second period of time, if the one or more conditions of the operating channel are not acceptable for use in communicating with the second node and the first node has not previously waited for the operating channel;
determining, by the first node, whether an other radio frequency channel is available for use by the first node, if the one or more conditions of the operating channel are not acceptable for use in communicating with the second node and the first node has previously waited for the operating channel;
setting, by the first node, the operating channel of the first node to the other radio frequency channel; and
determining, by the first node, whether the one or more conditions of the operating channel are acceptable for use in communicating with the second node.

20. The non-transitory computer-readable medium according to claim 19, wherein the one or more conditions comprise an indication of channel occupancy.

21. The non-transitory computer-readable medium according to claim 19, wherein the one or more conditions comprise an indication of channel load.

22. The non-transitory computer-readable medium according to claim 19, wherein the one or more conditions comprise a data transmission rate.

23. The non-transitory computer-readable medium according to claim 19, wherein the second period of time is randomly chosen.

24. The non-transitory computer-readable medium according to claim 19, further comprising:
broadcasting the operating channel, by the first node, to neighboring network nodes.

25. The non-transitory computer-readable medium according to claim 24, wherein the broadcasting is performed by the first node using a radio frequency channel different from the operating channel.

26. The non-transitory computer-readable medium according to claim 19, wherein the first channel is selected by the first node from a plurality of radio frequency channels.

27. The non-transitory computer-readable medium according to claim 19, wherein one or both of the first node and the second node comprise two or more physical layer interfaces (PHY) independently capable of communication on a same plurality of radio frequency channels.
